(19) United States
(12) Patent Application Publication
(10) Pub. No.: US 2026/0051278 A1
(43) Pub. Date: Feb. 19, 2026

(54) RENDERING METHOD FOR DISPLAY PANEL, DISPLAY PANEL AND DISPLAY DEVICE

(71) Applicant: Shanghai Tianma Microelectronics Co., Ltd., Shanghai (CN)

(72) Inventor: Bojia LYU, Shanghai (CN)

(21) Appl. No.: 19/367,829

(22) Filed: Oct. 24, 2025

(30) Foreign Application Priority Data
Nov. 29, 2024 (CN) 202411754158.8

(51) Int. Cl. G09G 3/20; G09G 3/32

(52) U.S. Cl. CPC G09G 3/2007; G09G 3/32; G09G 2300/0804; G09G 2320/0233; G09G 2320/0242; G09G 2320/028; G09G 2320/064; G09G 2320/0686; G09G 2330/023

(57) ABSTRACT

Provided are a rendering method for a display panel, a display panel and a display device. The display panel includes pixels. The rendering method includes: determining a to-be-rendered pixel data group according to image data of a to-be-displayed image, where the to-be-rendered pixel data group includes initial grayscales respectively corresponding to a plurality of pixels, and a reference grayscale of the to-be-rendered pixel data group is smaller than or equal to a first preset value; and obtaining a corresponding spatially rendered pixel data group based on the initial grayscales in the to-be-rendered pixel data group, where the spatially rendered pixel data group includes rendered grayscales respectively corresponding to the plurality of pixels, and each rendered grayscale other than the 0 grayscale in the spatially rendered pixel data group is greater than the first preset value.

### CROSS-REFERENCE TO RELATED APPLICATIONS

The present application claims priority to Chinese Patent Application No. 202411754158.8 filed on Nov. 29, 2024, the content of which is incorporated herein by reference in its entirety.

### TECHNICAL FIELD

The present disclosure relates to the field of display technologies, and in particular, to a rendering method for a display panel, a display panel and a display device.

### BACKGROUND

An existing display panel usually adopts a driving method such as pulse amplitude modulation (PAM) and/or pulse width modulation (PWM), and each of these two driving methods (PAM and PWM) has its own advantages and disadvantages. Regardless of which driving method is adopted by the display panel, the power consumption, the display uniformity and the image expression reliability are all issues that need to be considered.

### SUMMARY

In view of this, embodiments of the present disclosure provide a rendering method for a display panel, a display panel and a display device to solve the above problems.

In an aspect, an embodiment of the present disclosure provides a rendering method for a display panel. The display panel includes pixels. The rendering method includes: determining a to-be-rendered pixel data group according to image data of a to-be-displayed image, the to-be-rendered pixel data group including a plurality of initial grayscales respectively corresponding to a plurality of pixels, and a reference grayscale of the to-be-rendered pixel data group being smaller than or equal to a first preset value, and the reference grayscale being one of the plurality of initial grayscales other than 0 grayscale in the to-be-rendered pixel data group; and obtaining a corresponding spatially rendered pixel data group based on the plurality of initial grayscales in the to-be-rendered pixel data group, the spatially rendered pixel data group including a plurality of rendered grayscales respectively corresponding to the plurality of pixels, a number of 0 grayscale in the spatially rendered pixel data group being greater than a number of 0 grayscale in the corresponding to-be-rendered pixel data group, and each of the plurality of rendered grayscales other than 0 grayscale in the spatially rendered pixel data group being greater than the first preset value.

In another aspect, an embodiment of the present disclosure provides a display panel. The display panel includes pixels, and the pixels are configured to display Q1 brightness values; the display panel includes at least one spatially rendered region when displaying at least one frame of an image; and one of the at least one spatially rendered region includes a plurality of pixels; in each of the at least one spatially rendered region, a brightness of each pixel other than a pixel with a brightness of 0 is greater than a second preset value; and when the pixel is within the spatially rendered region, the pixel is configured to display part of the Q1 brightness values.

In another aspect, an embodiment of the present disclosure provides a display device including the display panel provided in the foregoing aspect.

### BRIEF DESCRIPTION OF DRAWINGS

In order to better illustrate the technical solutions in the embodiments of the present disclosure, the drawings, which are intended to be used in the description of the embodiments, are briefly described as below. It will be apparent that other drawings described below are merely some embodiments of the present disclosure, and other drawings may be obtained by those skilled in the art according to these drawings without paying any creative efforts.

FIG. 1 is a driving schematic diagram of a display panel according to an embodiment of the present disclosure;

FIG. 2 is a schematic diagram of a rendering method for a display panel according to an embodiment of the present disclosure;

FIG. 3 is a schematic flowchart of a rendering method for a display panel according to an embodiment of the present disclosure;

FIG. 4 is a schematic diagram of image data of two to-be-displayed images related to an embodiment of the present disclosure;

FIG. 5 is a schematic flowchart of a rendering method for a display panel according to an embodiment of the present disclosure;

FIG. 6 is a schematic flowchart of a rendering method for a display panel according to an embodiment of the present disclosure;

FIG. 7 is a schematic diagram of a relationship between a to-be-rendered pixel data group and a spatially rendered pixel data group according to an embodiment of the present disclosure;

FIG. 8 is a schematic flowchart of a rendering method for a display panel according to an embodiment of the present disclosure;

FIG. 9 is a schematic diagram of a relationship between a to-be-rendered pixel data group and a spatially rendered pixel data group according to an embodiment of the present disclosure;

FIG. 10 is a schematic flowchart of a rendering method for a display panel according to an embodiment of the present disclosure;

FIG. 11 is a schematic diagram of a rendering method for a display panel according to an embodiment of the present disclosure;

FIG. 12 is a schematic diagram of a rendering method for a display panel according to an embodiment of the present disclosure;

FIG. 13 is a schematic diagram of a rendering method for a display panel according to an embodiment of the present disclosure;

FIG. 14 is a schematic diagram of a relationship between a spatially rendered pixel data group and a spatially rendered region according to an embodiment of the present disclosure;

FIG. 15 is a schematic diagram of a relationship between a spatially rendered pixel data group and a spatially rendered region according to an embodiment of the present disclosure;

FIG. 16 is a schematic diagram of a relationship between a spatially rendered pixel data group and a spatially rendered region according to an embodiment of the present disclosure;

FIG. 17 is a schematic diagram of a relationship between a spatially rendered pixel data group and a spatially rendered region according to an embodiment of the present disclosure;

FIG. 18 is a rendering schematic diagram of a display panel according to an embodiment of the present disclosure;

FIG. 19 is a rendering schematic diagram of a display panel according to an embodiment of the present disclosure;

FIG. 20 is a schematic flowchart of a rendering method for a display panel according to an embodiment of the present disclosure;

FIG. 21 is a schematic diagram of a rendering method for a display panel according to an embodiment of the present disclosure;

FIG. 22 is a schematic flowchart of a rendering method for a display panel according to an embodiment of the present disclosure;

FIG. 23 is a schematic diagram of a rendering method for a display panel according to an embodiment of the present disclosure;

FIG. 24 is a schematic diagram of a display panel according to an embodiment of the present disclosure;

FIG. 25 a schematic diagram of a display panel according to an embodiment of the present disclosure;

FIG. 26 is a schematic diagram of a display panel according to an embodiment of the present disclosure;

FIG. 27 is a schematic diagram of a display panel according to an embodiment of the present disclosure;

FIG. 28 is a schematic diagram of a display panel according to an embodiment of the present disclosure;

FIG. 29 is a schematic diagram of a display panel according to an embodiment of the present disclosure;

FIG. 30 is a schematic diagram of a display panel according to an embodiment of the present disclosure;

FIG. 31 is a schematic diagram of a display panel according to an embodiment of the present disclosure;

FIG. 32 is a schematic diagram of a display panel according to an embodiment of the present disclosure; and

FIG. 33 is a schematic diagram of a display device according to an embodiment of the present disclosure.

### DESCRIPTION OF EMBODIMENTS

In order to better illustrate the technical solutions of the present disclosure, embodiments of the present disclosure are described in detail below in conjunction with the drawings.

It should be noted that, the described embodiments are only some rather than all of the embodiments of the present disclosure. All other embodiments obtained by those skilled in the art without creative efforts according to the embodiments of the present disclosure are within the protection scope of the present disclosure.

Terms used in the embodiments of the present disclosure are merely for the purpose of describing particular embodiments but not intended to limit the present disclosure. Singular forms of “a/an”, “said” and “the” used in the embodiments of the present disclosure and the appended claims are also intended to include plural forms, unless the context clearly indicates other meaning otherwise.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

In the description of the present disclosure, it should be understood that the terms such as “substantially”, “approximate to”, “approximately”, “about”, “roughly”, and “in general” described in the claims and embodiments of the present disclosure mean general agreement within a reasonable process operation range or tolerance range, rather than an exact value.

It should be noted that, although expressions “first”, “second” are used to describe specific thresholds, preset values, directions, etc., these should not be limited to these terms. These terms are used only to distinguish such as specific thresholds, preset values, directions from each other. For example, without departing from the scope of the embodiments of the present disclosure, a first direction can also be referred to as a second direction, and similarly, a second direction can also be referred to as a first direction. Through careful and in-depth research, the Applicant provides solutions to the problems in the related art.

For current mainstream display panels, common driving methods include pulse amplitude modulation (PAM) and pulse width modulation (PWM). For example, a liquid crystal display (LCD) panel and an organic light-emitting diode (OLED) panel are usually driven by PAM, that is, the pixels are controlled to display different grayscale brightness values by changing the magnitude of the data voltages received by the pixels therein. For example, a micro-light-emitting diode (Micro-LED) display panel usually adopts a driving method of PWM or a combination of PWM and PAM, that is, the pixels are controlled to display different grayscale brightness values at least by changing the light-emitting durations of the pixels therein.

Since the light-emitting efficiency and optical characteristics of the Micro-LED are greatly affected by the current density, when the current received by the Micro-LED changes, not only the brightness of the Micro-LED changes, but also the light-emitting wavelength and power consumption of the Micro-LED change accordingly. If the Micro-LED display panel only adopts PAM, the Micro-LED display panel has problems in terms of the power consumption and display consistency. Therefore, the Micro-LED display panel may adopt a driving method of PWM or a combination of PWM and PAM, so as to solve the problem of the Micro-LED display panel in terms of power consumption and display consistency due to its own characteristics.

FIG. 1 is a driving schematic diagram of a display panel according to an embodiment of the present disclosure.

When the driving method of the display panel for light-emitting display is PWM, the display effect of the display panel at a low grayscale is not ideal. The main reason is that, due to the limitation of the mobility of transistors, as shown in FIG. 1, an enable signal for controlling a light-emitting duration of the pixel is not a standard square wave, but has a rising edge and a falling edge. When the pixel displays low grayscale brightness, a proportion of a duration of the rising edge of the enable signal to a total duration of the enable signal is large, resulting in the brightness distortion of the pixel when displaying a low grayscale and an uncontrollable effective light-emitting duration.

In order to solve the above problems, embodiments of the present disclosure provide a rendering method for a display panel, a display panel and a display device.

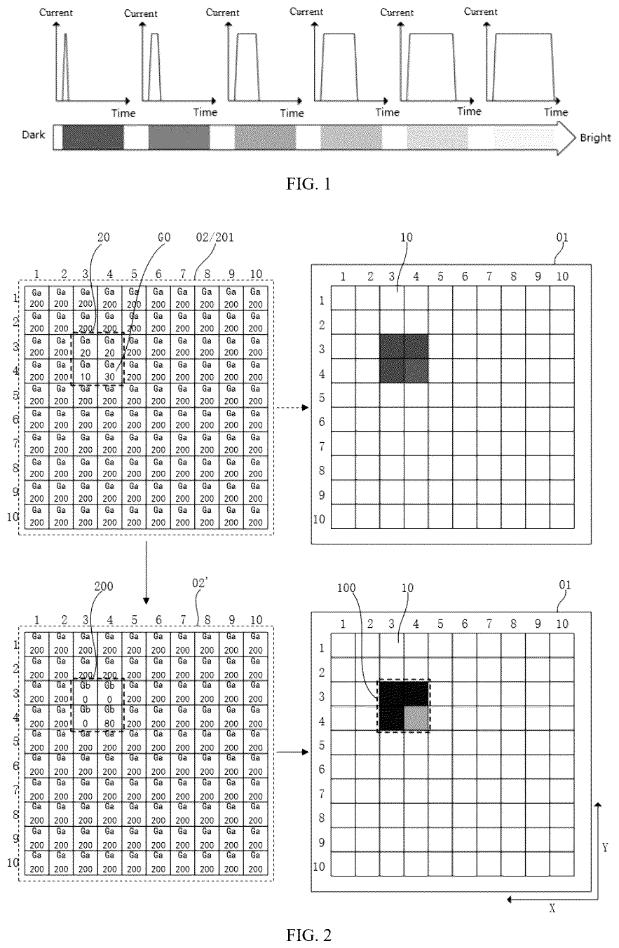

FIG. 2 is a schematic diagram of a rendering method for a display panel according to an embodiment of the present disclosure. It should be noted that, as shown in FIG. 2, the display panel 01 includes pixels 10. After the image data 02 of a to-be-displayed image is processed by a driving module such as color correction and brightness compensation, a voltage signal that can be recognized by the display panel 01 is obtained. The voltage signal is transmitted to the display panel 01 to control the pixels 10 to emit light. In order to display different images, the light-emission of different pixels 10 may be individually controllable, that is, the light-emission durations of different pixels 10 may be individually controllable. Therefore, a voltage signal for respectively controlling the light-emission duration of each pixel 10 may be obtained according to the image data 02. Correspondingly, the image data 02 includes an initial grayscale Ga corresponding to each pixel 10 in the display panel 01.

For ease of understanding, as shown in FIG. 2, the initial grayscale Ga in the image data 02 is illustrated as an array. The initial grayscale Ga in the array form has a one-to-one correspondence with each of the pixels 10 arranged in an array in the display panel 01. For example, as shown in FIG. 2, the display panel 01 includes 10 rows and 10 columns of pixels 10. The image data 02 may be regarded as including 10 rows and 10 columns of initial grayscales Ga. An initial grayscale Ga in row 1, column 1 is an initial grayscale Ga corresponding to a pixel 10 in row 1, column 1 of the display panel 01. An initial grayscale Ga in row 1, column 2 is an initial grayscale Ga corresponding to a pixel 10 in row 1, column 2 of the display panel 01 . . . . An initial grayscale Ga in row 10, column 10 is an initial grayscale Ga corresponding to a pixel 10 in row 10, column 10 of the display panel 01.

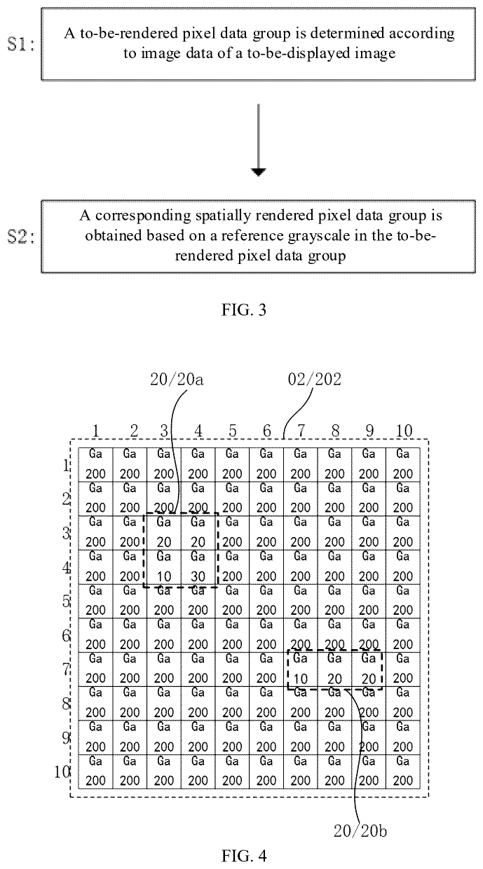

FIG. 3 is a schematic flowchart of a rendering method for a display panel according to an embodiment of the present disclosure. In this embodiment of the present disclosure, with reference to FIG. 2 and FIG. 3, the rendering method provided in this embodiment of the present disclosure includes the following steps.

S1: a to-be-rendered pixel data group 20 is determined according to image data 02 of a to-be-displayed image.

The to-be-rendered pixel data group 20 includes initial grayscales Ga respectively corresponding to the plurality of pixels 10. The image data 02 of the to-be-displayed image includes the initial grayscale Ga of each pixel 10. The to-be-rendered pixel data group 20 may be considered as a part of the image data 02 of the to-be-displayed image, that is, the to-be-rendered pixel data group 20 includes an initial grayscale Ga corresponding to the to-be-rendered pixel 10 in the image data 02. For example, as shown in FIG. 2, the to-be-rendered pixel data group 20 includes 4 initial grayscales Ga corresponding to a pixel 10 in row 3 and column 3, a pixel 10 in row 3 and column 4, a pixel 10 in row 4 and column 3, and a pixel 10 in row 4 and column 4, respectively.

In addition, a reference grayscale G0 of the to-be-rendered pixel data group 20 is smaller than or equal to a first preset value, and the reference grayscale G0 is an initial grayscale Ga in the to-be-rendered pixel data group 20 except for 0 grayscale. That is, the to-be-rendered pixel data group 20 determined in this step includes at least one initial grayscale Ga that is greater than 0 grayscale and smaller than or equal to the first preset value. For example, as shown in FIG. 2, the to-be-rendered pixel data group 20 includes grayscale values of initial grayscales Ga respectively corresponding to a pixel 10 in row 3, column 3, a pixel 10 in row 3, column 4, a pixel 10 in row 4, column 3, and a pixel 10 in row 4, column 4 respectively, with their grayscale values being 20, 20, 10, and 30. The grayscale value of the reference grayscale G0 may be 30, that is, the initial grayscale Ga corresponding to the pixel 10 in row 4, column 4 may be the reference grayscale G0.

When the reference grayscale G0 is smaller than or equal to the first preset value, it means that when the pixel 10 corresponding to the reference grayscale G0 displays the reference grayscale G0, the time duration for receiving an enable signal is relatively short. As shown in the image data 02 and the display panel 01 at the right side thereof in FIG. 2, when the reference grayscale G0 in the to-be-rendered pixel data group 20 is smaller than or equal to the first preset value, then when the display panel 01 displays the to-be-displayed image, the pixels 10 corresponding to the to-be-rendered pixel data group 20 are driven by the PWM signals corresponding to the reference grayscales G0 to emit light, resulting in a problem of relatively serious brightness distortion.

The reference grayscale G0 of the to-be-rendered pixel data group 20 is smaller than or equal to the first preset value, and this may be configured as one of the basis for selecting the to-be-rendered pixel data group 20 from the image data 02 of the to-be-displayed images, then when displaying the to-be-displayed images, if a plurality of pixels 10 corresponding to the to-be-rendered image data group 02 are driven to emit light in a PWM manner, brightness distortion of these pixels 10 is relatively serious, thereby resulting in an obvious uneven brightness region of the displayed picture.

FIG. 4 is a schematic diagram of image data of two to-be-displayed images related to an embodiment of the present disclosure.

It should be noted that the image data 02 of one to-be-displayed image may include a plurality of to-be-rendered pixel data groups 20, for example, as shown in FIG. 4, the image data 02 of one to-be-displayed image is the image data 202, which includes a to-be-rendered pixel data group 20a and a to-be-rendered pixel data group 20b.

It should be further noted that the to-be-rendered pixel data groups 20 included in the image data 02 respectively corresponding to different to-be-displayed images may be different. For example, in combination with FIG. 2 and FIG. 4, the image data 02 of the to-be-displayed image shown in FIG. 2 is the image data 201, which includes one to-be-rendered pixel data group 20; and the image data 02 of the to-be-displayed image shown in FIG. 4 is the image data 202, which includes two to-be-rendered pixel data groups 20.

A plurality of to-be-rendered pixel data groups 20 included in the image data 02 of a same to-be-displayed image may be same or different. For example, as shown in FIG. 4, the to-be-rendered pixel data group 20a included in the image data 02 of the to-be-displayed image includes 4 initial grayscales Ga, and the to-be-rendered pixel data group 20b included in the image data 02 includes 3 initial grayscales Ga.

S2: a corresponding spatially rendered pixel data group 200 is obtained based on the initial grayscales Ga in the to-be-rendered pixel data group 20.

A spatially rendered pixel data group 200 includes rendered grayscales Gb corresponding to a plurality of pixels 10, and the rendered grayscales Gb other than 0 grayscale in the spatially rendered pixel data group 200 are greater than the first preset value. At least some of the initial grayscales Ga in the to-be-rendered pixel data group 20 are increased to obtain the rendered grayscales Gb in the spatial rendered pixel data group 200. In the corresponding spatially rendered pixel data group 200 and to-be-rendered pixel data group 20, the pixels 10 respectively corresponding to the rendered grayscales Gb are same as the pixels 10 respectively corresponding to the initial grayscales Ga.

Since the rendered grayscales Gb with the grayscale value greater than 0 in the spatially rendered pixel data group 200 is greater than the first preset value, then when the display panel 01 displays the to-be-displayed image, a light-emitting duration of the pixel 10 corresponding to the rendered grayscale Gb other than 0 grayscale is prolonged, that is, a duration of the enable signal related to the light-emitting duration received by the pixel 10 is prolonged. The image data including the to-be-rendered pixel data group 20 is represented as the image data 02, and the image data including the spatially rendered pixel data group 200 is represented as image data 02′. As shown in the image data 02′ and display panel 01 at the right side thereof in FIG. 2, when the rendered grayscale with the grayscale value greater than 0 in the spatial rendering image data group 200 is greater than the first preset value, then when the display panel 01 displays the to-be-displayed image, the pixel 10 corresponding to the spatially rendered pixel data group 200 is driven to emit light by the PWM signal corresponding to the rendered grayscale Gb. The brightness increase of the pixel 10 benefits from the increase of the brightness thereof, thereby alleviating the brightness distortion.

When the display panel 01 displays the to-be-displayed image, a region of the pixels 10 corresponding to each rendered grayscale Gb in the spatially rendered pixel data group 200 is referred to as a spatially rendered region 100. In this embodiment of the present disclosure, the initial grayscale Ga in the to-be-rendered pixel data group 20 is changed to the rendered grayscale Gb to obtain the spatially rendered pixel data group 200, enabling the display brightness of the spatially rendered region 100 to be closer to an ideal brightness of the to-be-displayed image in this region.

However, when the rendered grayscale Gb other than 0 grayscale in the spatially rendered pixel data group is greater than the first preset value, it means that the grayscale values of some of the initial grayscales Ga in the to-be-rendered pixel data group 20 are increased to rendered grayscales Gb greater than the first preset value. Then, when display panel 01 displays the to-be-displayed image, these rendered grayscales Gb enable the brightness of the corresponding pixels 10 to be higher than original ideal brightness of these pixels 10.

Therefore, in order to make the brightness of the spatially rendered region 100 not significantly higher than an ideal value, a number of 0 grayscale in the spatially rendered pixel data group 200 is greater than a number of 0 grayscale in a corresponding to-be-rendered pixel data group 20. Therefore, in the rendered grayscale Gb in the spatially rendered region 100, grayscale values of some of the rendered grayscales Gb are increased relative to the initial grayscales Ga, while grayscale values of some other of the rendered grayscales Gb are decreased relative to the initial grayscales Ga to be 0 grayscale, enabling the brightness of the spatially rendered region 100 to be close to the ideal brightness. That is, when the display panel 01 displays a to-be-displayed image, a pixel 10 corresponding to the rendered grayscale Gb with a grayscale value greater than 0 and a pixel 10 corresponding to the rendered grayscale Gb with a grayscale value equal to 0 in the spatially rendered pixel data group 200 perform brightness rendering, enabling the brightness of the spatially rendered region 100 to be close to the ideal brightness. For example, as shown in FIG. 2, in the corresponding spatially rendered pixel data group 200 and to-be-rendered pixel data group 20, a number of rendered grayscales Gb with a grayscale value of 0 in the spatially rendered pixel data group 200 is 3, and a number of initial grayscales Ga with a grayscale value of 0 in the to-be-rendered pixel data group 20 is 0.

In addition, the rendered grayscale Gb in the spatially rendered pixel data group 200 is either greater than the first preset value or 0 grayscale. A ratio of the duration of the rising edge and the falling edge of the voltage signal for controlling the light-emitting duration of the pixel 10 corresponding to the rendered grayscale Gb greater than the first preset value to the total duration of the voltage signal is increased, and a total duration of the voltage signal for controlling the light-emitting duration of the pixel 10 corresponding to 0 grayscale is 0. Therefore, it may solve the problem in the related art that significant distortion occurs in brightness expression of pixels 10 displaying low grayscales when the PWM method is used to drive the pixels 10 to emit light.

A grayscale value of the rendered grayscale Gb is same as a grayscale value of at least one of the initial grayscales Ga. If the image information may include 256 initial grayscales Ga in total, 0 grayscale-255 grayscale, a grayscale value of the rendered grayscale Gb is same as a grayscale value of at least one of the 256 initial grayscales Ga. For example, as shown in FIG. 2, the grayscale values of the rendered grayscales Gb included in the spatially rendered pixel data group 200 are respectively 0 grayscale and 80 grayscale.

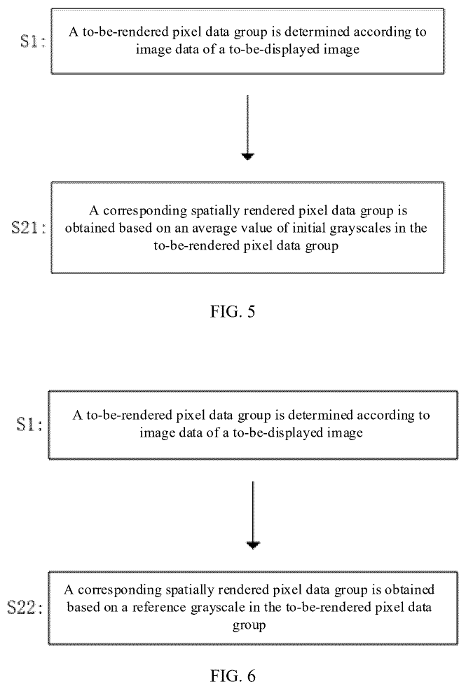

FIG. 5 is a schematic flowchart of a rendering method for a display panel according to an embodiment of the present disclosure.

In an embodiment of the present disclosure, as shown in FIG. 5, the S2 “a corresponding spatially rendered pixel data group 200 being obtained based on the initial grayscales Ga in the to-be-rendered pixel data group 20” includes the following steps.

S21: a corresponding spatially rendered pixel data group 200 is obtained based on an average value of the initial grayscales Ga included in the to-be-rendered pixel data group 20.

An average value of the initial grayscales Ga included in the to-be-rendered pixel data group 20 may reflect an ideal average brightness of the to-be-displayed image in the spatially rendered region 100 corresponding to the to-be-rendered pixel data group 20. Therefore, the rendered grayscale Gb in the spatially rendered pixel data group 200 obtained in this embodiment can make the average brightness of the spatially rendered region 100 corresponding to the spatially rendered pixel data group 200 substantially equal to the ideal average brightness when the display panel 01 displays the to-be-displayed image.

In a technical solution corresponding to this embodiment, in a corresponding spatially rendered pixel data group 200 and the to-be-rendered pixel data group 20, an average value of rendered grayscales Gb in the spatially rendered pixel data group 200 is substantially equal to an average value of rendered grayscales Ga in the to-be-rendered pixel data group 20. For example, as shown in FIG. 2, if an average value of the initial grayscales Ga in the to-be-rendered pixel data group 20 is 20 and the to-be-rendered pixel data group 20 includes 4 initial grayscales Ga, an average value of the rendered grayscales Gb in the corresponding spatially rendered pixel data group 200 in the to-be-rendered pixel data group 20 is 20.

When the rendered grayscale Gb in the spatially rendered pixel data group 200 is obtained through calculation based on the consideration that an average brightness of the spatially rendered region 100 corresponding to the spatially rendered pixel data group 200 is substantially equal to the ideal average brightness of the spatially rendered region 100, it is also necessary to consider that the rendered brightness of the pixels 10 in the spatially rendered region 100 may be affected by factors such as a distance between the pixels 10. Therefore, in other technical solutions, when the spatially rendered pixel data group 200 is obtained according to the to-be-rendered pixel data group 20, the average value of the initial grayscales Ga in the to-be-rendered pixel data group 20 and the foregoing factors need to be comprehensively considered.

FIG. 6 is a schematic flowchart of a rendering method for a display panel according to an embodiment of the present disclosure.

In an embodiment of the present disclosure, as shown in FIG. 6, the S2 “a corresponding spatially rendered pixel data group 200 being obtained based on the initial grayscales Ga in the to-be-rendered pixel data group 20” includes the following steps.

S22: a corresponding spatially rendered pixel data group 200 is obtained based on the reference grayscale G0 in the to-be-rendered pixel data group 20.

The corresponding spatially rendered pixel data group 200 being obtained based on the reference grayscale G0 in the to-be-rendered pixel data group 20 may refer to: obtaining the rendered grayscale Gb in the spatially rendered pixel data group 200 with reference to the grayscale value of the reference grayscale G0 in the to-be-rendered pixel data group 10. When the display panel 01 displays the to-be-displayed image, the spatially rendered pixel data group 200 may enable the actual average display brightness of the spatially rendered region 100 to be substantially equivalent to the ideal brightness corresponding to the reference grayscale G0.

In a technical solution corresponding to this embodiment, in the spatially rendered pixel data group 200 obtained based on the reference grayscale G0 in the to-be-rendered pixel data group 20, the average value of the rendered grayscales Gb is substantially equal to the grayscale value of the reference grayscale G0 in the to-be-rendered pixel data group 20.

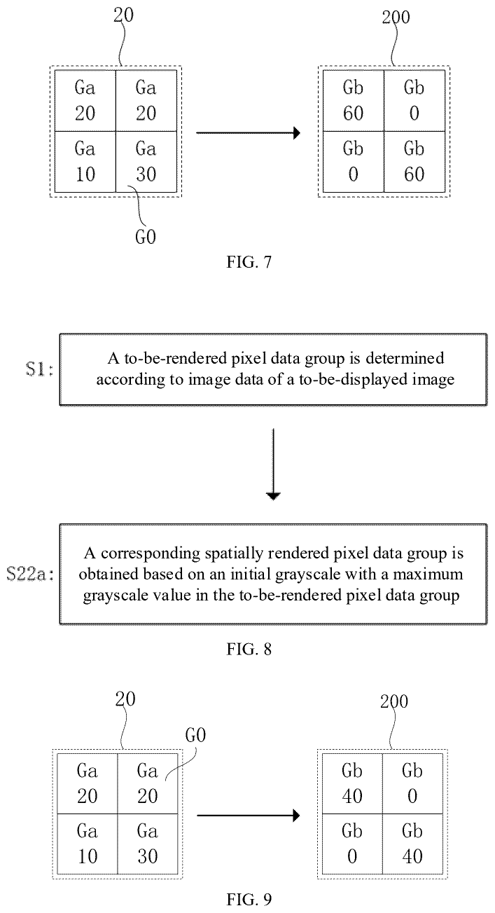

FIG. 7 is a schematic diagram of a relationship between a to-be-rendered pixel data group and a spatially rendered pixel data group according to an embodiment of the present disclosure.

For example, as shown in FIG. 7, in a corresponding to-be-rendered pixel data group 20 and the spatially rendered pixel data group 200, the initial grayscales Ga included in the to-be-rendered pixel data group 20 are 20, 20, 10, and 30, and the initial grayscale Ga with the grayscale value of 30 may be configured as the reference grayscale G0. The rendered grayscales Gb in the spatially rendered pixel data group 200 are 0, 0, 60, and 60 respectively, and an average value of the rendered pixels 10 in the spatially rendered pixel data group 200 is 30.

When the rendered grayscale Gb in the spatially rendered pixel data group 200 is obtained through calculation based on the consideration that an average brightness of the spatially rendered region 100 corresponding to the spatially rendered pixel data group 200 is substantially equal to the ideal brightness of the reference grayscale G0, it is also necessary to consider that the rendered brightness of the pixels 10 in the spatially rendered region 100 may be affected by factors such as a distance between the pixels 10. Therefore, in other technical solutions, when the spatially rendered pixel data group 200 is obtained according to the to-be-rendered pixel data group 20, the average value of the reference grayscales G0 in the to-be-rendered pixel data group 20 and the foregoing factors need to be comprehensively considered.

In an embodiment of the present disclosure, the reference grayscale G0 is an initial grayscale Ga of a maximum value included in the to-be-rendered pixel data group 20. For example, as shown in FIG. 2 and FIG. 7, the to-be-rendered pixel data group 20 includes initial grayscales Ga with grayscale values of 10, 10, 20, and 30, respectively, and then the initial grayscale Ga with the grayscale value of 30 may be configured as the reference grayscale G0.

In this embodiment, a maximum initial grayscale Ga in the to-be-rendered pixel data group 20 is smaller than or equal to the first preset value. That is, only the initial grayscale Ga with a grayscale value smaller than or equal to the first preset value can be classified into the to-be-rendered pixel data group 20, while the initial grayscale Ga with a grayscale value greater than the first preset value does not belong to the spatially rendered pixel data group 200. Since only the initial grayscale Ga with the grayscale value smaller than or equal to the first preset value needs to be converted to the rendered grayscale Gb, when converting the to-be-rendered pixel data group 20 to the spatially rendered pixel data group 200, the required buffer space is smaller and the requirement for computing power is lower.

FIG. 8 is a schematic flowchart of a rendering method for a display panel according to an embodiment of the present disclosure.

In addition, when the reference grayscale G0 is an initial grayscale Ga of a maximum grayscale value included in the to-be-rendered pixel data group 20, as shown in FIG. 8, the S2 “a corresponding spatially rendered pixel data group 200 being obtained based on the reference grayscale G0 in the to-be-rendered pixel data group 20” includes the following steps.

S22a: a corresponding spatially rendered pixel data group 200 is obtained based on an initial grayscale Ga with a maximum grayscale value in the to-be-rendered pixel data group 20. For example, as shown in FIG. 7, the initial grayscale Ga with a grayscale value of 30 in the to-be-rendered pixel data group 20 is configured as the reference grayscale G0, and an average value of the rendered grayscales Gb in the obtained spatial rendered pixel data group 200 is 30, that is, the rendered grayscale Gb is obtained based on the reference grayscale G0.

For the spatially rendered pixel data group 200 obtained based on the initial grayscale Ga with the maximum grayscale value in the to-be-rendered pixel data group 20, when the display panel 01 displays the to-be-displayed image, the brightness of the spatially rendered region 100 is basically equivalent to the ideal brightness corresponding to the initial grayscale Ga with the maximum grayscale value in the to-be-rendered pixel data group 20. Then, when the display panel 01 displays the to-be-displayed image, the spatially rendered region 100 may include fewer pixels 10 that do not emit light (i.e., the pixel 10 corresponding to the rendered grayscale Gb with a grayscale value of 0). That is, the ideal brightness may be obtained by rendering the pixel 10 that emits light (i.e., the pixel 10 corresponding to the rendered grayscale Gb with a grayscale value greater than the first preset value). Therefore, a region of the spatially rendered region 100 is relatively small, so that the display panel 01 does not lose excessive details when displaying an image.

FIG. 9 is a schematic diagram of a relationship between a to-be-rendered pixel data group and a spatially rendered pixel data group according to an embodiment of the present disclosure.

In an embodiment of the present disclosure, the grayscale value of the reference grayscale G0 is the median of the grayscale values of the initial grayscales Ga included in the to-be-rendered pixel data group 20. For example, as shown in FIG. 9, if the to-be-rendered pixel data group 20 includes initial grayscales Ga with grayscale values of 20, 20, 10, and 30, the initial grayscale Ga with grayscale value of 20 may be configured as the reference grayscale G0.

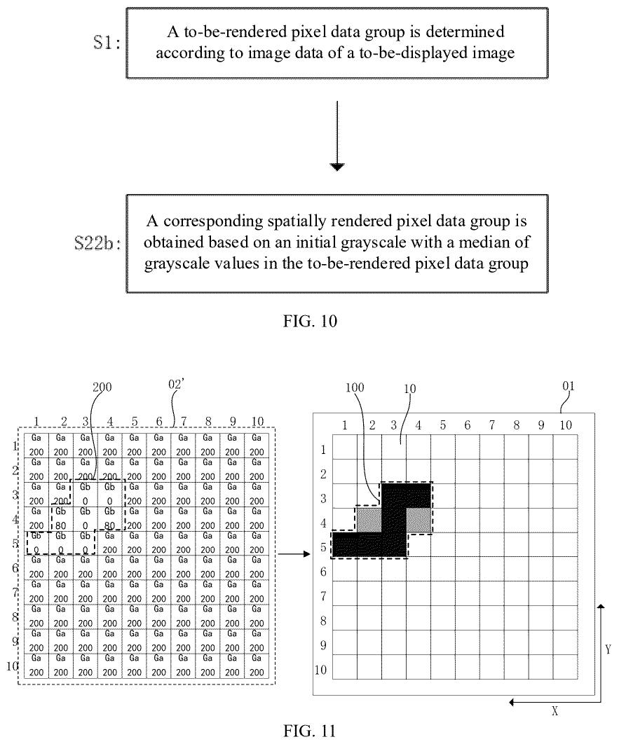

FIG. 10 is a schematic flowchart of a rendering method for a display panel according to an embodiment of the present disclosure.

In addition, when the grayscale value of the reference grayscale G0 is a median of the grayscale values of the plurality of initial grayscale Ga included in the to-be-rendered pixel data group 20, as shown in FIG. 10, the S2 “a corresponding spatially rendered pixel data group 200 being obtained based on the reference grayscale G0 in the to-be-rendered pixel data group 2” includes the following steps.

S22b: a corresponding spatially rendered pixel data group 200 is obtained based on an initial grayscale Ga with a median of the grayscale values in the to-be-rendered pixel data group 20. For example, as shown in FIG. 9, the initial grayscale Ga with a grayscale value of 20 in the to-be-rendered pixel data group 20 is configured as the reference grayscale G0, and an average value of the rendered grayscales Gb in the obtained spatial rendered pixel data group 200 is 20, that is, the rendered grayscale Gb is obtained based on the reference grayscale G0.

In this embodiment, since the grayscale value of the reference grayscale G0 is the median of the grayscale values of the plurality of initial grayscales Ga included in the to-be-rendered pixel data group 20, the median of the brightness of the plurality of pixels 10 corresponding to the to-be-rendered pixel data group 20 in the to-be-displayed image is taken as the reference brightness. Therefore, when the display panel 01 displays the to-be-displayed image, the brightness of the spatially rendered region 100 corresponding to the spatially rendered pixel data group 200 is basically equivalent to the aforementioned reference brightness. Since when the display panel 01 displays an image, the brightness values of the pixels 10 at adjacent positions usually do not change abruptly, the brightness perceived by the human eye when observing a small region in the display panel 01 can be basically characterized by the median of the brightness of the plurality of pixels 10 in this region. Therefore, in the rendering method of the present embodiment, when the display panel 01 displays the to-be-displayed image, the brightness of the spatially rendered region 100 observed by human eyes is basically equivalent to an ideal brightness of the region.

In addition, by taking the median of the multiple initial grayscales Ga included in the to-be-rendered pixel data group 20 as the reference grayscale G0, in the obtained spatially rendered pixel data group 200, a value of the rendered grayscale Gb does not need to be too large, the corresponding driving power consumption does not need to be too large, and the service life of the light-emitting device in the pixel 10 can be ensured.

The inventors verified the display effect of the display panel 01 and found that when driving the pixel 10 to emit light using the PWM method, the brightness expression distortion corresponding to grayscale values greater than or equal to 64 basically does not affect the display quality of the to-be-displayed image.

In an embodiment of the present disclosure, the first preset value is smaller than or equal to 64 grayscale. Therefore, the reference grayscale G0 in the to-be-rendered pixel data group 20 is smaller than or equal to 64 grayscale, and each rendered grayscale Gb other than 0 grayscale in the spatially rendered pixel data group 200 is greater than 64 grayscale. For example, as shown in FIG. 2, each reference grayscale in the to-be-rendered pixel data group 20 is smaller than 64 grayscale, and each rendered grayscale Gb other than 0 grayscale in the spatially rendered pixel data group 200 is greater than 64 grayscale.

In a technical solution corresponding to this embodiment, the first preset value is 32 grayscale. Therefore, the reference grayscale G0 in the to-be-rendered pixel data group 20 is smaller than or equal to 32 grayscale, and each rendered grayscale Gb other than 0 grayscale in the spatially rendered pixel data group 200 is greater than 32 grayscale. For example, as shown in FIG. 2, FIG. 4, FIG. 7 and FIG. 9, each initial grayscale Ga in the to-be-rendered pixel data group 20 is smaller than 32 grayscale. As shown in FIG. 2, FIG. 7 and FIG. 9, each rendered grayscale Gb other than 0 grayscale in the spatially rendered pixel data group 200 is greater than 32 grayscale. When the first preset value is 32 grayscale, a number of initial grayscales Ga that need to be changed to the rendered grayscales Gb is relatively small, which makes the computing power requirement to be relatively low and enables easy implementation.

As described above, the effect of the rendering method in the embodiments of the present disclosure is ultimately exhibited through each pixel 10 in the spatially rendered region 100 performing brightness rendering. Therefore, the pixels 10 in the spatially rendered region 100 should be concentrated to achieve brightness rendering.

In an embodiment of the present disclosure, the pixels 10 included in the display panel 01 are arranged in an array along a first direction X and a second direction Y, and the first direction X intersects with the second direction Y. In an embodiment, the first direction X is perpendicular to the second direction Y. For example, as shown in FIG. 2, the first direction X is a row direction and the second direction Y is a column direction.

Among the pixels 10 respectively corresponding to the plurality of initial grayscales Ga included in a same to-be-rendered pixel data group 20, the pixels 10 arranged along the first direction X are arranged adjacently in sequence, and/or the pixels 10 arranged along the second direction Y are arranged adjacently in sequence. That is, among the pixels 10 respectively corresponding to the plurality of rendered grayscales Gb included in the spatially rendered pixel data group 200, the pixels 10 arranged along the first direction X are arranged adjacently in sequence, and/or the pixels 10 arranged along the second direction Y are arranged adjacently in sequence. That is, among the plurality of pixels 10 included in the spatially rendered region 100, the pixels 10 arranged along the first direction X do not include a pixel 10 that does not belong to the spatially rendered region 100, and the pixels 10 arranged along the second direction Y do not include a pixel 10 that does not belong to the spatially rendered region 100.

FIG. 11 is a schematic diagram of a rendering method for a display panel according to an embodiment of the present disclosure.

For example, as shown in FIG. 2 and FIG. 11, regardless of the shape of the spatially rendered region 100 being a rectangle or other shape different from the rectangle, when the display panel 01 displays the to-be-displayed image, the pixels 10 arranged along the first direction X in the spatially rendered region 100 are sequentially adjacently arranged and the pixels 10 arranged along the second direction Y are sequentially adjacently arranged.

In this embodiment of the present disclosure, the pixels 10 in the spatially rendered region 100 are more concentrated, thus making it easier to achieve brightness rendering. Furthermore, it avoids pixels 10 that do not belong to the spatially rendered region 100 from being surrounded or partially surrounded by pixels 10 in the spatially rendered region 100, thus also avoiding pixels 10 that do not belong to the spatially rendered region 100 from affecting the brightness rendering effect of the spatially rendered region 100.

In an embodiment of the present disclosure, a difference between any two initial grayscales Ga in the to-be-rendered pixel data group 20 is smaller than or equal to a first threshold, and the first threshold is smaller than a first preset value. For example, if the first preset value is 32 grayscale, the first threshold is smaller than or equal to 32 grayscale, then, a difference between any two initial grayscales Ga in the to-be-rendered pixel data group 20 is smaller than or equal to 32 grayscale.

A difference between any two initial grayscales Ga in the to-be-rendered pixel data group 20 is smaller than or equal to the first threshold, that is, grayscale values of different initial grayscales Ga in the to-be-rendered pixel data group 20 do not differ greatly.

On one hand, when the display panel 01 displays the to-be-displayed image, the pixels 10 with different brightness values in the spatially rendered region 100 perform brightness rendering, and the brightness in the spatially rendered region 100 after rendering expresses the ideal brightness corresponding to the specific initial grayscale value in the to-be-rendered pixel data group 20. If grayscale values of some initial grayscales Ga in the to-be-rendered pixel data group 20 differ greatly, a difference of the ideal brightness values of the plurality of pixels 10 in the spatially rendered region 100 is larger, that is, the ideal brightness values of the plurality of pixels 10 in the spatially rendered region 100 are too rich. In the embodiments of the present disclosure, since grayscale values of different initial grayscales Ga in the to-be-rendered pixel data group 20 do not differ greatly, it avoids a problem that it is too difficult to express richer ideal brightness by using spatial rendering.

On the other hand, since grayscale values of different initial grayscales Ga in the to-be-rendered pixel data group 20 do not differ greatly, a difference between the reference grayscale G0 in the to-be-rendered pixel data group 20 and other initial grayscale Ga is not large. Thus, it is easier to obtain the rendered grayscale, that is, it is easier to implement spatial rendering.

In an embodiment of the present disclosure, any initial grayscale Ga in the to-be-rendered pixel data group 20 is smaller than or equal to a second threshold, and the second threshold is smaller than or equal to the first preset value. For example, if the first preset value is 32 grayscale, the second threshold is smaller than or equal to 32 grayscale, and then any initial grayscale Ga in the to-be-rendered pixel data group 20 is smaller than or equal to 32 grayscale.

If any initial grayscale Ga in the to-be-rendered pixel data group 20 is smaller than or equal to the second threshold, the ideal brightness of the plurality of image pixels in the corresponding spatially rendered region 100 in the to-be-displayed image is smaller than or equal to the ideal brightness corresponding to the second threshold, that is, the ideal brightness of the plurality of image pixels in the corresponding spatially rendered region 100 in the displayed image is relatively small.

On one hand, in this embodiment, only the initial grayscale Ga with a grayscale value smaller than or equal to the second threshold is classified into the to-be-rendered pixel data group 20, that is, only the initial grayscale Ga with a grayscale value smaller than or equal to the second threshold is changed to obtain the rendered grayscale, and the required computing power is relatively low.

On the other hand, the initial grayscales Ga in the to-be-rendered pixel data group 20 are all smaller than or equal to the second threshold, so that fewer rendered grayscales Gb are configured to represent the rendered brightness of the spatially rendered region 100. In this embodiment, a number of initial grayscales Ga in the to-be-rendered pixel data group 20 is small and a number of rendered grayscales Gb in the spatially rendered pixel data group 200 is small, so that when the display panel 01 displays the to-be-displayed image, a number of pixels 10 included in the spatially rendered region 100 is small, and therefore, the resolution of the to-be-displayed image during displaying may not be excessively reduced.

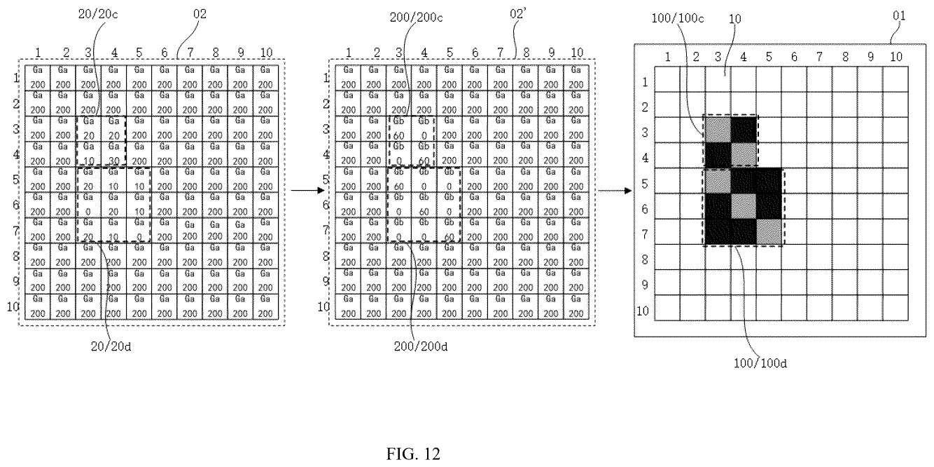

FIG. 12 is a schematic diagram of a rendering method for a display panel according to an embodiment of the present disclosure.

In an embodiment of the present disclosure, when the reference grayscale G0 of the to-be-rendered pixel data group 20 is within a first range, a number of pixels 10 respectively corresponding to the rendered grayscales Gb included in the corresponding spatially rendered pixel data group 200 is n1. When the reference grayscale G0 of the to-be-rendered pixel data group 20 is within a second range, a number of pixels 10 respectively corresponding to the rendered grayscales Gb included in the corresponding spatially rendered pixel data group 200 is m1. A maximum value of the first range is smaller than or equal to a minimum value of the second range, and n1 is greater than m1.

The smaller the value of the reference grayscale G0 in the to-be-rendered pixel data group 20 is, basically the lower the brightness of the spatially rendered region 100 corresponding to the to-be-rendered pixel data group 20 is, then, when the target brightness is obtained by rendering the brightness of the plurality of pixels 10 in the spatially rendered region 100, more pixels 10 may participate in the rendering to obtain the target brightness, and then the to-be-rendered pixel data group 20 needs to include more initial grayscales Ga. The larger the value of the reference grayscale G0 in the to-be-rendered pixel data group 20 is, basically the higher the brightness of the spatially rendered region 100 corresponding to the to-be-rendered pixel data group 20, then when the target brightness is obtained by rendering the brightness of the plurality of pixels 10 in the spatially rendered region 100, fewer pixels 10 may participate in the rendering to obtain the target brightness, and then the to-be-rendered pixel data group 20 needs to include fewer initial grayscales Ga.

Taking FIG. 12 as an example for illustration, the image data 02 of the to-be-displayed image includes a to-be-rendered pixel data group 20c and a to-be-rendered pixel data group 20d. If the initial grayscale Ga with a maximum grayscale value in the to-be-rendered pixel data group 20 is configured as the reference grayscale G0, a grayscale value of the reference grayscale G0 in the to-be-rendered pixel data group 20c is 30 and a grayscale value of the reference grayscale G0 in the to-be-rendered pixel data group 20d is 20. If the rendered grayscale Gb is obtained based on the reference grayscale G0 and the average value of the rendered grayscales Gb in the spatially rendered pixel data group 200 is substantially equal to the reference grayscale G0, then when the grayscale value of the rendered grayscale Gb other than 0 grayscale is 60, the to-be-rendered pixel data group 20c needs to include 4 initial grayscales Ga, to ensure that the average value of the corresponding 4 rendered grayscales Gb in the spatially rendered pixel data group 200c is 30, thereby enabling the rendered brightness of the 4 pixels 10 in the corresponding spatially rendered region 100c to be close to the ideal brightness corresponding to 30 grayscale; and the to-be-rendered pixel data group 20d needs to include 9 initial grayscales Ga, so that the average value of the corresponding 9 rendered grayscales Gb in the spatially rendered region 200d is 20, to ensure that the rendered brightness of the 9 pixels 10 in the corresponding spatially rendered region 100d is close to the ideal brightness corresponding to 20 grayscale.

In a technical solution corresponding to this embodiment, grayscale values of rendered grayscales Gb other than 0 grayscale in the spatially rendered pixel data group 200 may be equal, in this case, a number of pixels 10 participating in brightness rendering in the spatially rendered region 100 may be determined by reasonably selecting a number of initial grayscales Ga in the to-be-rendered pixel data group 20. When the grayscale values of the rendered grayscales Gb other than the 0 grayscale in the spatially rendered pixel data group 200 are equal, it can reduce the computing power required when obtaining the spatial rendering pixel data group 200 from the to-be-rendered pixel data group 20.

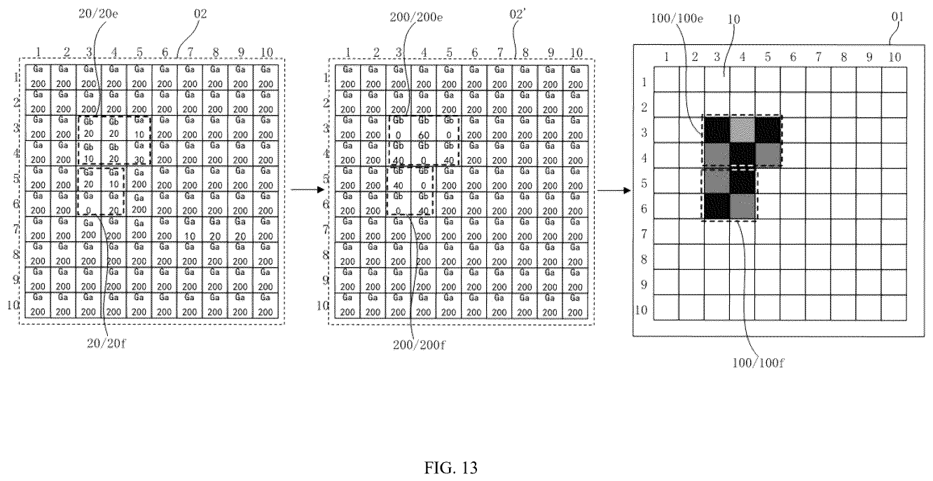

FIG. 13 is a schematic diagram of a rendering method for a display panel according to an embodiment of the present disclosure.

In an embodiment of the present disclosure, when the reference grayscale G0 of the to-be-rendered pixel data group 20 is within a first range, a corresponding spatially rendered pixel data group 200 includes n2 different grayscale values. When the reference grayscale G0 of the to-be-rendered pixel data group 20 is within a second range, a corresponding spatially rendered pixel data group 200 includes m2 different grayscale values. A maximum value of the first range is smaller than or equal to a minimum value of the second range, and n2 is greater than m2.

Taking FIG. 13 as an example for illustration, the image data 02 of the to-be-displayed image includes a to-be-rendered pixel data group 20e and a to-be-rendered pixel data group 20f. If the initial grayscale Ga with a maximum grayscale value in the to-be-rendered pixel data group 20 is configured as the reference grayscale G0, a grayscale value of the reference grayscale G0 in the to-be-rendered pixel data group 20e is 30 and a grayscale value of the reference grayscale G0 in the to-be-rendered pixel data group 20f is 20. If the rendered grayscale Gb is obtained based on the reference grayscale G0 and the average value of the rendered grayscales Gb in the spatially rendered pixel data group 200 is substantially equal to the reference grayscale G0, the to-be-rendered pixel data group 20e may include rendered grayscales Gb with 3 different grayscale values of 0, 40, and 60, and the to-be-rendered pixel data group 20f may include rendered grayscales Gb with 2 different grayscale values of 0 and 40.

In an embodiment of the present disclosure, the spatially rendered pixel data group 200 includes 2 rendered grayscales Gb with different values, that is, the spatially rendered pixel data group includes a rendered grayscale Gb with a grayscale value 0 and a rendered grayscale Gb with a grayscale value greater than the first preset value. For example, as shown in FIG. 2 and FIG. 11, the rendered grayscales Gb included in the spatially rendered pixel data group 200 are respectively 0 grayscale and 80 grayscale. For example, as shown in FIG. 7 and FIG. 12, the rendered grayscales Gb included in the spatially rendered pixel data group 200 are respectively 0 grayscale and 60 grayscale. For example, as shown in FIG. 9, the rendered grayscales Gb included in the spatially rendered pixel data group 200 are respectively 0 grayscale and 40 grayscale.

In the embodiments, if a number of rendered grayscales Gb of different grayscale values in the spatially rendered pixel data group 200 is relatively small, the rendering is mainly implemented by selecting the number of rendered grayscales Gb included in the spatially rendered pixel data group 200, and the algorithm is relatively simple.

In an embodiment of the present disclosure, at least one spatially rendered pixel data group 200 includes 3 or more different rendered grayscales Gb, that is, the spatially rendered pixel data group 200 includes a rendered grayscale Gb with a grayscale value of 0 and at least two rendered grayscales Gb with different grayscale values greater than the first preset value. For example, as shown in FIG. 13, the spatially rendered pixel data group 200e includes a rendered grayscale Gb with a grayscale value of 0, a rendered grayscale Gb with a grayscale value of 40, and a rendered grayscale Gb with a grayscale value of 60.

In the embodiments, if the number of rendered grayscales Gb of different grayscale values in the spatially rendered pixel data group 200 is large, the spatially rendered pixel data group 200 may achieve more target brightness of different brightness values through a limited number of rendered grayscales Gb.

In an embodiment of the present disclosure, a number of different grayscale values included in the spatially rendered pixel data group 200 is smaller than a number of rendered grayscales Gb included in the spatially rendered pixel data group 200. For example, as shown in FIG. 2, FIG. 7, FIG. 9, FIG. 11, and FIG. 12, rendered grayscales Gb in each spatially rendered pixel data group 200 have 2 grayscale values, and each spatially rendered pixel data group 200 includes at least 4 rendered grayscales Gb. For example, as shown in FIG. 13, the rendered grayscales Gb in the spatially rendered pixel data group 200e have 3 grayscale values and the spatially rendered pixel data group 200e includes 6 rendered grayscales Gb.

When a number of rendered grayscales Gb of different grayscale values included in the spatially rendered pixel data group 200 is smaller than a total number of rendered grayscales Gb included in the spatially rendered pixel data group 200, the computing power requirement for rendering is relatively small.

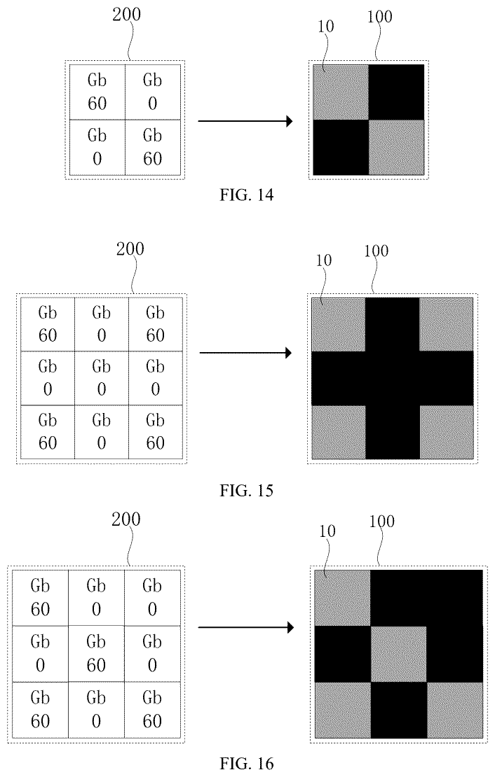

FIG. 14 is a schematic diagram of a relationship between a spatially rendered pixel data group and a spatially rendered region according to an embodiment of the present disclosure. FIG. 15 is a schematic diagram of a relationship between a spatially rendered pixel data group and a spatially rendered region according to an embodiment of the present disclosure.

In an embodiment of the present disclosure, as shown in FIG. 14 and FIG. 15, pixels 10 respectively corresponding to a plurality of rendered grayscales Gb included in a same spatially rendered pixel data group 200 are evenly arranged. When the display panel 01 displays the to-be-displayed image, pixels 10 with a same brightness included in a same spatially rendered region 100 are evenly arranged.

For example, as shown in FIG. 14, the spatially rendered pixel data group 200 includes 4 rendered grayscales Gb, where 2 of the rendered grayscales Gb have a grayscale value greater than 0 and the other 2 of the rendered grayscales Gb have a grayscale value of 0. Correspondingly, the spatially rendered region 100 corresponding to this spatially rendered pixel data group 200 includes 2×2 pixels 10. In this embodiment, when the display panel 01 displays the to-be-displayed image, 2 pixels 10 (gray pixels) with a display brightness greater than 0 grayscale in the spatially rendered region 100 corresponding to the spatially rendered pixel data group 200 are evenly arranged, and 2 pixels 10 (black pixels) with a display brightness equal to 0 grayscale are evenly arranged.

For example, as shown in FIG. 15, the spatially rendered pixel data group 200 includes 9 rendered grayscales Gb, where 4 of the rendered grayscales Gb have a grayscale value greater than 0 and the other 5 of the rendered grayscales Gb have a grayscale value of 0. Correspondingly, the spatially rendered region 100 corresponding to this spatially rendered pixel data group 200 includes 3×3 pixels 10. In this embodiment, when the display panel 01 displays the to-be-displayed image, 4 pixels 10 (gray pixels) with a display brightness greater than 0 grayscale in the spatially rendered region 100 corresponding to the spatially rendered pixel data group 200 are evenly arranged, and 5 pixels 10 (black pixels) with a display brightness equal to 0 grayscale are evenly arranged.

It should be noted that, in some spatially rendered pixel data groups 200, due to limitations imposed by the number of rendered grayscales Gb and/or the number of rendered grayscales Gb with a same grayscale value, an arrangement rule of the pixels 10 with a same brightness in the spatially rendered region 100 corresponding to these spatially rendered pixel data groups 200 is not obvious. For example, when the spatially rendered region 100 corresponding to the spatially rendered pixel data group 200 includes 2×2 pixels 10 and the spatially rendered pixel data group 200 includes only 1 rendered grayscale Gb with a grayscale value greater than 0, then when the display panel 01 displays a to-be-displayed image, the spatially rendered region 100 includes only 1 pixel 10 with a display brightness greater than 0 grayscale, which cannot reflect an arrangement rule of even distribution. Therefore, in this embodiment of the present disclosure, that pixels 10 respectively corresponding to a plurality of rendered grayscales Gb included in a same spatially rendered pixel data group 200 are evenly arranged may mean that pixels 10 respectively corresponding to rendered grayscales Gb in at least one spatially rendered pixel data group 200 meet the arrangement rule.

In an embodiment of the present disclosure, because pixels 10 with a same brightness in a same spatially rendered region 100 are evenly arranged in the region, the display brightness of the spatially rendered region 100 may be relatively even.

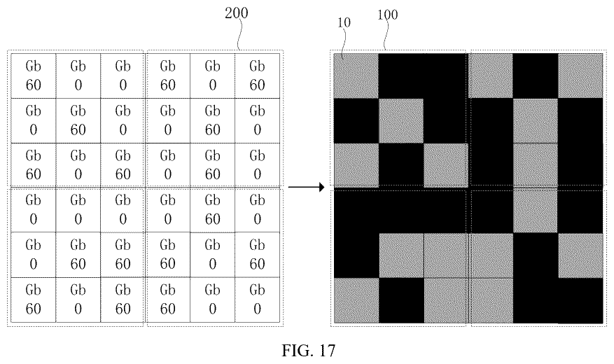

FIG. 16 is a schematic diagram of a relationship between a spatially rendered pixel data group and a spatially rendered region according to an embodiment of the present disclosure.

In an embodiment of the present disclosure, pixels 10 respectively corresponding to a same rendered grayscale Gb included in a same spatially rendered pixel data group 200 are randomly arranged. When the display panel 01 displays the to-be-displayed image, the pixels 10 with a same brightness in a same spatially rendered region 100 are randomly arranged.

For example, as shown in FIG. 16, the spatially rendered pixel data group 200 includes 9 rendered grayscales Gb, where 4 of the rendered grayscales Gb have a grayscale value of 60 and the other 5 of the rendered grayscales Gb have a grayscale value of 0. Correspondingly, the spatially rendered region 100 corresponding to this spatially rendered pixel data group 200 includes 3×3 pixels 10. In this embodiment, when the display panel 01 displays the to-be-displayed image, the 4 pixels 10 (in the spatially rendered region 100 corresponding to the spatially rendered pixel data group 200) that correspond to the rendered grayscale Gb with a grayscale value of 60 (in terms of display brightness) are randomly arranged, and the 5 pixels 10 corresponding to 0 grayscale are randomly arranged. That is, the arrangement of pixels 10 with a same brightness in the spatially rendered region 100 is irregular.

It should be noted that the computer language corresponding to the random arrangement of the pixels 10 with a same brightness is a random algorithm, and it can be understood that when the random algorithm is used, in some cases, the pixels 10 with a same brightness in the spatially rendered region 100 may present a certain rule. As long as the pixels 10 with a same brightness in most of the spatially rendered regions 100 are irregularly arranged; and/or, when the display panel 01 displays most of the to-be-displayed image, the pixels 10 with a same brightness in the spatially rendered region 100 are irregularly arranged, it may be considered that the pixels 10 respectively corresponding to a same rendered grayscale Gb included in a same spatially rendered pixel data group 200 are randomly arranged.

In an embodiment of the present disclosure, the pixels 10 with a same brightness in a same spatially rendered region 100 are randomly arranged, the occurrence of obvious bright stripes, dark stripes, etc. on the display panel 01 at a specific viewing angle rows can be avoided, thereby improving the display effect of the display panel 01.

FIG. 17 is a schematic diagram of a relationship between a spatially rendered pixel data group and a spatially rendered region according to an embodiment of the present disclosure.

In an embodiment of the present disclosure, as shown in FIG. 17, the pixels 10 respectively corresponding to the rendered grayscales Gb greater than 0 grayscale included in a plurality of spatially rendered pixel data groups 200 are randomly arranged. When the display panel 01 displays the to-be-displayed image including a plurality of spatially rendered regions 100, the pixels 10 with a same brightness in the plurality of spatially rendered regions 100 are randomly arranged.

It should be noted that even if the pixels 10 corresponding to the rendered grayscales of a same grayscale value in a plurality of spatially rendered pixel data groups 200 are randomly arranged, the unit for implementing the brightness rendering in the technical solution of the present disclosure is also the spatially rendered region 100, and the rendered grayscale Gb obtained by the initial grayscale Ga operation in the to-be-rendered pixel data group 20 still belongs to the spatially rendered pixel data group 200 corresponding to the to-be-rendered pixel data group 20.

For example, as shown in FIG. 17, each of the 4 spatially rendered pixel data groups 200 includes a plurality of rendered grayscales Gb with grayscale values greater than 0. The 4 spatially rendered regions 100 corresponding to the 4 spatially rendered pixel data groups 200 are regarded as a whole, and pixels 10 with brightness values greater than 0 in the whole are randomly arranged.

In the embodiments of the present disclosure, the pixels 10 with a same brightness in a plurality of spatially rendered regions 100 are randomly arranged, the occurrence of obvious bright stripes, dark stripes, etc. on the display panel 01 at a specific viewing angle can be avoided, thereby improving the display effect of the display panel 01.

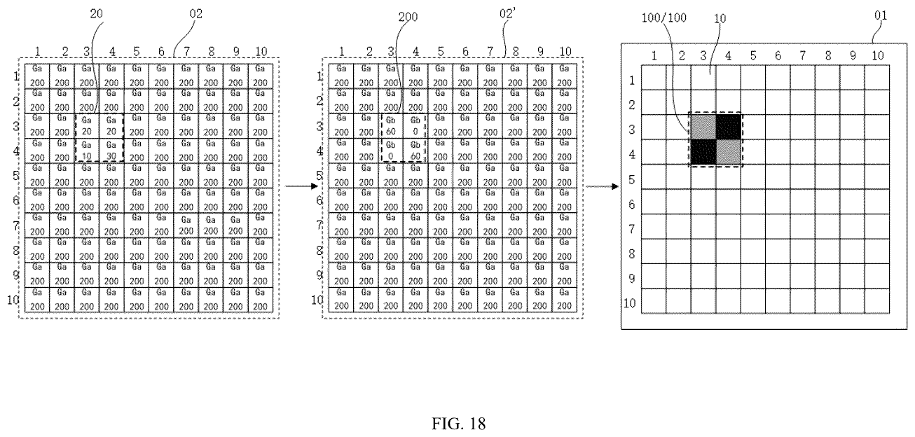

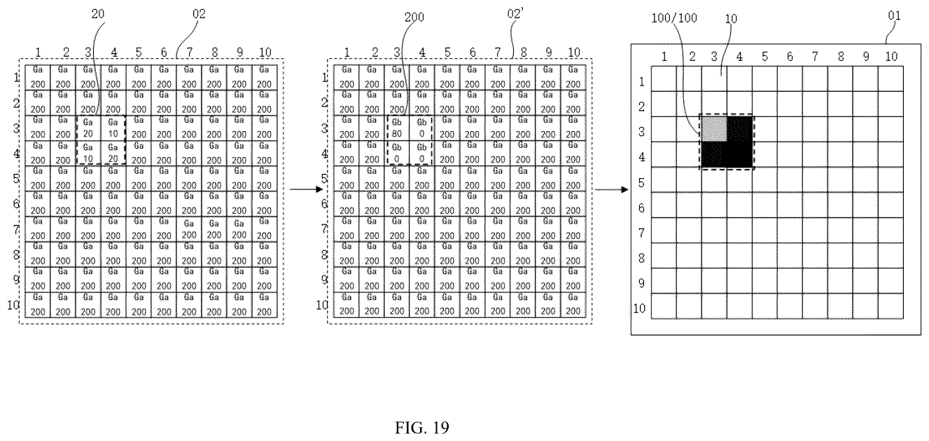

FIG. 18 is a rendering schematic diagram of a display panel according to an embodiment of the present disclosure. FIG. 19 is a rendering schematic diagram of a display panel according to an embodiment of the present disclosure.

In an embodiment of the present disclosure, as shown in FIG. 2, FIG. 18, and FIG. 19, in a corresponding spatially rendered pixel data group 200 and the to-be-rendered pixel data group 20, a maximum initial grayscale Ga corresponds to a maximum rendered grayscale Gb, and a pixel 10 of a minimum initial grayscale Ga corresponds to a minimum rendered grayscale Gb.

For example, as shown in FIG. 2, the initial grayscale Ga with a maximum grayscale value in the to-be-rendered pixel data group 20 is the initial grayscale Ga corresponding to the pixel 10 in row 4 and column 4 of the display panel 01, then the rendered grayscale Gb corresponding to the pixel 10 in row 4 and column 4 of the display panel 01 is the rendered grayscale Gb with a maximum grayscale value in the spatially rendered pixel data group 200. In addition, the initial grayscale Ga with a minimum grayscale value in the to-be-rendered pixel data group 20 is the initial grayscale Ga corresponding to the pixel 10 in row 4 and column 3 of the display panel 01, then the rendered grayscale Gb corresponding to the pixel 10 in row 4 and column 3 of the display panel 01 is the rendered grayscale Gb with a maximum grayscale value in the spatially rendered pixel data group 200.

It should be noted that in the spatially rendered pixel data group 200 and the to-be-rendered pixel data group 20, the initial grayscale Ga with a maximum grayscale value does not necessarily correspond to the rendered grayscale Gb with a maximum grayscale value in one-to-one correspondence, and the initial grayscale Ga with a minimum grayscale value does not necessarily correspond to the rendered grayscale Gb with a minimum grayscale value in one-to-one correspondence.

For example, as shown in FIG. 18, the initial grayscale Ga with a maximum grayscale value in the to-be-rendered pixel data group 20 is the initial grayscale Ga corresponding to the pixel 10 in row 4 and column 4 of the display panel 01, while the rendered grayscale Gb with a maximum grayscale value in the spatially rendered pixel data group 200 is the rendered grayscale Gb corresponding to the pixel 10 in row 3 and column 3 and the pixel 10 in row 4 and column 4 of the display panel 01. For example, as shown in FIG. 19, the initial grayscale Ga with a maximum grayscale value in the to-be-rendered pixel data group 20 is the initial grayscale Ga corresponding to the pixel 10 in row 3 and column 3 and the pixel 10 in row 4 and column 4 of the display panel 01, while the rendered grayscale Gb with a maximum grayscale value in the spatially rendered pixel data group 200 is the rendered grayscale Gb corresponding to the pixel 10 in row 3 and column 3 of the display panel 01.

For example, as shown in FIG. 2, the initial grayscale Ga with a minimum grayscale value in the to-be-rendered pixel data group 20 is the initial grayscale Ga corresponding to the pixel 10 in row 4 and column 3 of the display panel 01, while the rendered grayscale Gb with a minimum grayscale value in the spatially rendered pixel data group 200 is the rendered grayscale Gb corresponding to the pixel 10 in row 3 and column 3, the pixel 10 in row 3 and column 4, and the pixel 10 in row 4 and column 3 of the display panel 01. For example, as shown in FIG. 18, the initial grayscale Ga with a minimum grayscale value in the to-be-rendered pixel data group 20 is the initial grayscale Ga corresponding to the pixel 10 in row 4 and column 3 of the display panel 01, while the rendered grayscale Gb with a minimum grayscale value in the spatially rendered pixel data group 200 is the rendered grayscale Gb corresponding to the pixel 10 in row 3 and column 4 and the pixel 10 in row 4 and column 3 of the display panel 01. For example, as shown in FIG. 19, the initial grayscale Ga with a minimum grayscale value in the to-be-rendered pixel data group 20 is the initial grayscale Ga corresponding to the pixel 10 in row 3 and column 4 and the pixel 10 in row 4 and column 3 of the display panel 01, while the rendered grayscale Gb with a minimum grayscale value in the spatially rendered pixel data group 200 is the rendered grayscale Gb corresponding to the pixel 10 in row 3 and column 4, the pixel 10 in row 4 and column 3, and the pixel 10 in row 4 and column 4 of the display panel 01.

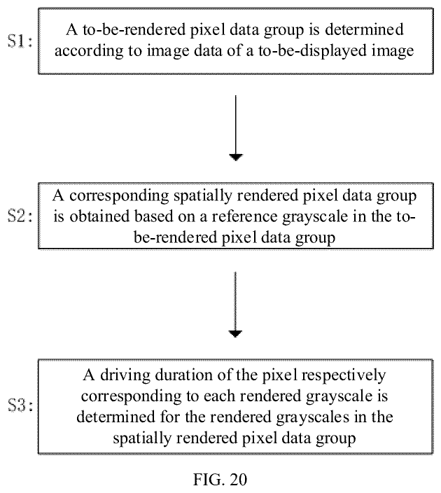

FIG. 20 is a schematic flowchart of a rendering method for a display panel according to an embodiment of the present disclosure.

In an embodiment of the present disclosure, as shown in FIG. 20, the rendering method provided in this embodiment of the present disclosure further includes the following steps.

S3: a driving duration of the pixel respectively corresponding to each rendered grayscale is determined for the rendered grayscales Gb in the spatially rendered pixel data group 200.

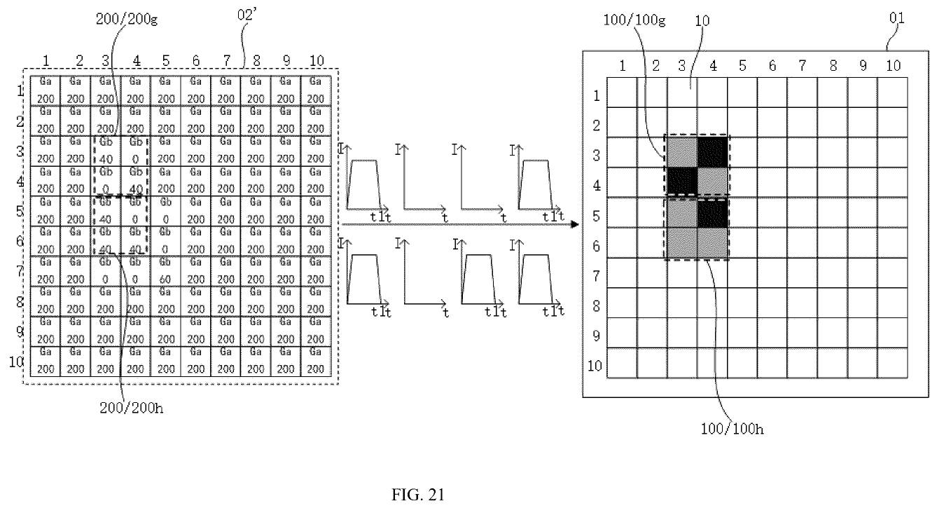

FIG. 21 is a schematic diagram of a rendering method for a display panel according to an embodiment of the present disclosure.

An example in which an average value of the rendered grayscales Gb in the spatially rendered pixel data group 200 is equal to an initial grayscale Ga with a maximum grayscale value in the corresponding to-be-rendered pixel data group 20 is configured for description. For example, as shown in FIG. 21, the driving duration corresponding to the rendered grayscale Gb equal to 0 in the spatially rendered pixel data group 200 is 0, and the driving duration corresponding to the rendered grayscale Gb greater than 0 in the spatially rendered pixel data group 200 is t1.

In an embodiment of the present disclosure, when the rendered brightness of the corresponding spatially rendered region 100 in the spatially rendered pixel data group 200 is different, a number of rendered grayscales Gb with different grayscale values in the spatially rendered pixel data group 200 and/or the grayscale value of the rendered grayscale Gb may be changed. Correspondingly, for example, as shown in FIG. 21, a pulse timing of the time t and the current I between the image data 02′ and the display panel 01 is a pulse signal for driving the pixel 10 to emit light obtained based on the rendered grayscale Gb.

The pulse timing above the arrow corresponds to the rendered grayscale Gb in the spatially rendered pixel data group 200g and pulse timing corresponding to the pixel 10 in the spatially rendered region 100g in the display panel 01, and the pulse timings below the arrow corresponds to the rendered grayscale Gb in the spatially rendered pixel data group 200h and the pulse timing corresponding to the pixel 10 in the spatially rendered region 100h in the display panel 01. When the rendered pixels 10 in different spatially rendered regions 100 have different brightness values, these different spatially rendered regions 100 correspond to different numbers of pixels with a driving duration of t1. For example, as shown in FIG. 21, a driving duration corresponding to 2 pixels 10 in the spatially rendered region 100g is t1, and a driving duration corresponding to 3 pixels 10 in the spatially rendered region 100g is t1.

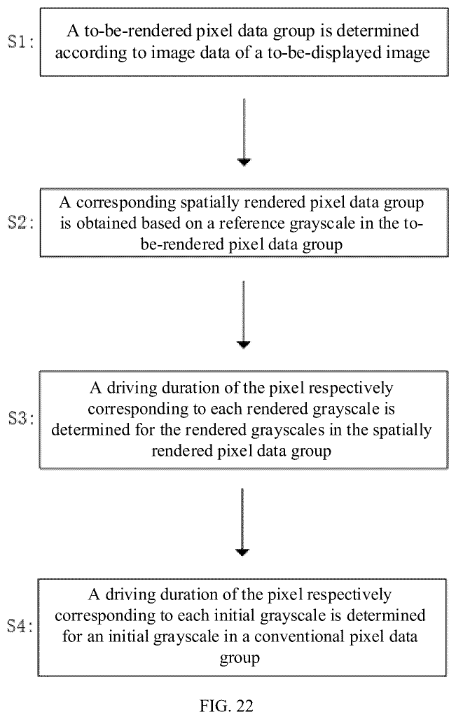

FIG. 22 is a schematic flowchart of a rendering method for a display panel according to an embodiment of the present disclosure.

In an embodiment of the present disclosure, as shown in FIG. 22, the rendering method provided in this embodiment of the present disclosure further includes:

S4: a driving duration of the pixel 10 respectively corresponding to the initial grayscale Ga is determined for each initial grayscale Ga in a conventional pixel data group. Each initial grayscale Ga in the conventional pixel 10 data group is greater than the first preset value.

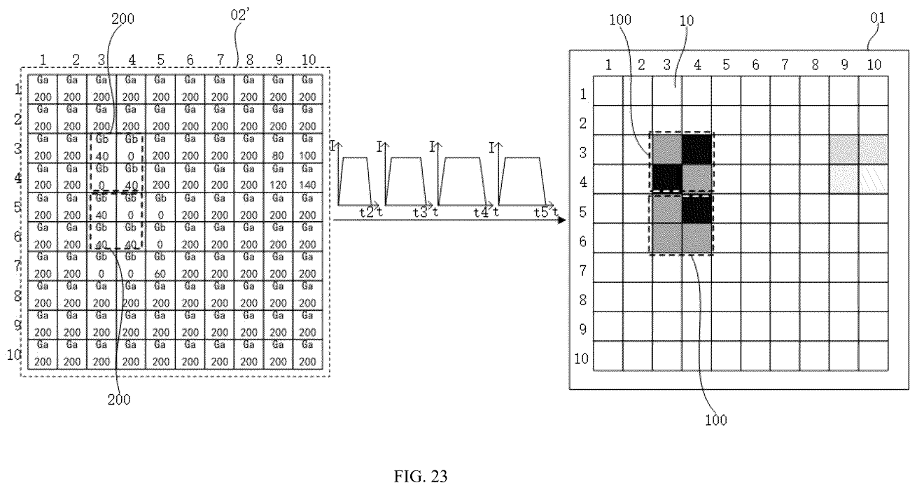

FIG. 23 is a schematic diagram of a rendering method for a display panel according to an embodiment of the present disclosure.

As shown in FIG. 23, the pulse timing above the arrow is the pulse timing of each of the initial grayscales Ga with a grayscale values of 80, 100, 120 and 140 and pixels 10 corresponding thereto. Then, the duration of the pixel 10 outside the spatially rendered region 100 being driven to emit light is related to the initial grayscale Ga thereof. For example, as shown in FIG. 23, driving durations of the pixels 10 respectively corresponding to the initial grayscales Ga with grayscale values of 80, 100, 120 and 140 are t2, t3, t4 and t5, and t2<t3<t4<t5.

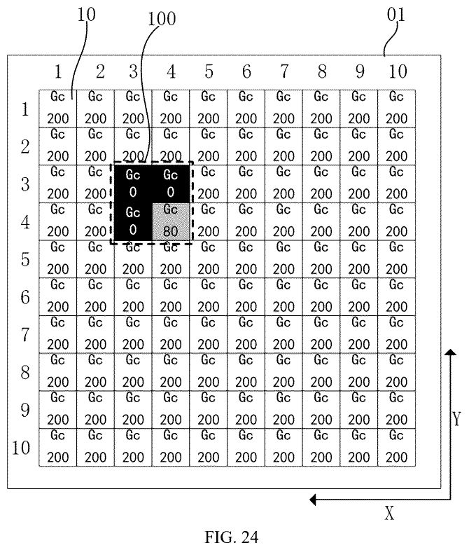

FIG. 24 is a schematic diagram of a display panel according to an embodiment of the present disclosure.

An embodiment of the present disclosure further provides a display panel 01, as shown in FIG. 24, the display panel 01 includes pixels 10. The pixels 10 are configured to display Q1 brightness values. The display panel 01 may emit light according to image data of different to-be-displayed images, so as to display these different to-be-displayed images respectively. The pixels 10 being configured to display Q1 brightness values means that each pixel 10 in the display panel 01 is capable of achieving Q1 brightness values. For example, Q1=256, that is, the pixel 10 can display the brightness corresponding to 0 grayscale to 255 grayscale.

In this embodiment of the present disclosure, when the display panel 01 displays at least one frame of an image, the display panel 01 includes at least one spatially rendered region 100. The spatially rendered region 100 includes a plurality of pixels 10. Each pixel 10 other than a pixel with a brightness of 0 in any spatially rendered region 100 is greater than a second preset value. Therefore, even if the display panel 01 displays the to-be-displayed image, the image data of the to-be-displayed image includes the initial grayscale corresponding to the brightness smaller than or equal to the second preset value. The pixels 10 in the spatially rendered region 100 do not display the brightness corresponding to the initial grayscale smaller than or equal to the second preset value, but instead display the brightness greater than the second preset value and the brightness equal to 0.

Assuming that the grayscale value of the initial grayscale corresponding to the second preset value is 32, as shown in FIG. 24, the display grayscales Gc corresponding to the brightness values of the 4 pixels 10 in the spatially rendered region 100 are respectively 0, 0, 0 and 80, where the brightness of the pixel 10 with a display grayscale Gc of 80 is greater than 32 grayscale.

When the pixels 10 are within the spatially rendered region 100, the pixels 10 are configured to display some of the Q1 brightness values. In addition, since the brightness of each pixel 10 in the spatially rendered region 100 other than the pixel 10 with the brightness of 0 is greater than the second preset value, then in the plurality of pixels 10 in the spatially rendered region 100, the pixels are configured to emit no light or emit a brightness greater than the second preset value. When some pixels 10 in the spatially rendered region 100 emit the brightness greater than the second preset value, even if the brightness is greater than a brightness corresponding to the initial grayscale of the pixel 10, the target brightness may be obtained because the brightness of the pixel 10 may perform brightness rendering with the pixel 10 with the brightness of 0 in the spatially rendered region 100.

In an embodiment of the present disclosure, the brightness of each pixel 10 in the spatially rendered region 100 is either 0 or greater than the second preset value, and the pixel 10 performs brightness rendering when being in the spatially rendered region 100. In addition, the pixel 10 in the spatially rendered region 100 emits light in a PWM driving manner, and when a brightness of the pixel 10 with a brightness greater than 0 in the spatially rendered region 100 is greater than the second preset value, the pixel 10 receives an enable signal for a longer duration, resulting in smaller significant issues with brightness expression distortion and flexible controllability of the brightness.

It should be noted that the spatially rendered region 100 in the display panel 01 performs brightness rendering on the pixel 10 with the brightness of 0 and the pixel 10 with the brightness greater than the second preset value, so that the spatially rendered region 100 entirely presents a brightness expression corresponding to a lower grayscale. Therefore, when the display panel 01 displays different to-be-displayed images, regions with lower brightness values may be different, that is, the spatially rendered region 100 is not an unchanged region in the display panel 01, but is a region determined according to an image displayed by the display panel 01. Therefore, pixels 10 in the spatially rendered region 100 are not unchanged pixels 10, but pixels 10 determined according to the spatially rendered region 100.

In an embodiment of the present disclosure, the brightness of a plurality of pixels 10 in the spatially rendered region 100 is smaller than brightness of any pixels 10 other than the pixel 10 with the brightness of 0 in the conventional display region. The conventional display region is a display region excluding the spatially rendered region 100.

In order to make the display panel 01 have the above light-emitting effects, any embodiment related to the above rendering method may be used to drive the display panel 01.

In an embodiment of the present disclosure, the second preset value is smaller than or equal to a brightness value corresponding to 64 grayscale. For example, if the second preset value is equal to 64 grayscale, the brightness of the pixel 10 in the spatially rendered region 100 is either 0 or greater than the brightness corresponding to 64 grayscale.

In a technical solution corresponding to this embodiment, the second preset value is a brightness value corresponding to 32 grayscale. The brightness of the pixel 10 in the spatially rendered region 100 is either 0 or greater than the brightness corresponding to 32 grayscale.

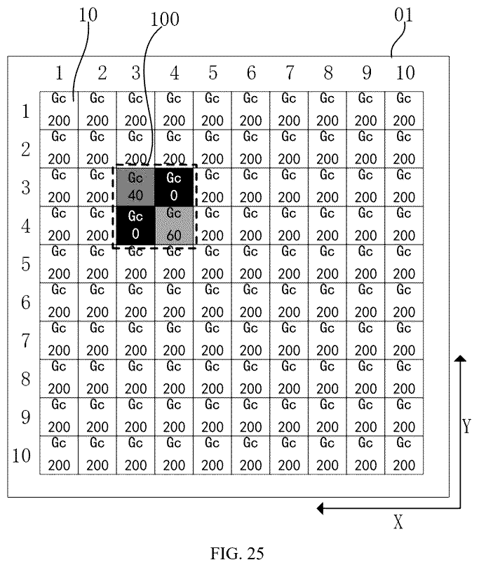

FIG. 25 is a schematic diagram of a display panel according to an embodiment of the present disclosure.

In an embodiment of the present disclosure, as shown in FIG. 25, a brightness difference between any two pixels with brightness greater than 0 in the spatially rendered region 100 is smaller than or equal to a third threshold, and the third threshold is smaller than or equal to the second preset value.

Assuming that the second preset value is the brightness corresponding to 64 grayscale, the third threshold is smaller than or equal to the brightness corresponding to 64 grayscale. The third threshold being the brightness corresponding to 64 grayscale is taken as an example for illustration. As shown in FIG. 25, the display grayscales Gc respectively corresponding to the brightness values of two pixels with the brightness greater than 0 in the spatially rendered region 100 are 40 and 60, and a difference between the two display grayscales Gc is smaller than or equal to 64, so that a difference between the two pixels in terms of the brightness is smaller than the brightness corresponding to 64 grayscale.

In the embodiments, a brightness difference of the pixels 10 with the brightness greater than 0 in the spatially rendered region 100 is relatively small, thereby avoiding the occurrence of obvious bright spots in the spatially rendered region 100, which would affect the display effect.

In an embodiment of the present disclosure, as shown in FIG. 25, the brightness of any pixel 10 in the spatially rendered region 100 is smaller than or equal to a fourth threshold. The fourth threshold is smaller than or equal to the second preset value.

Assuming that the second preset value is the brightness corresponding to 64 grayscale, the fourth threshold is smaller than or equal to the brightness corresponding to 64 grayscale. The fourth threshold being the brightness corresponding to 64 grayscale is taken as an example for illustration. As shown in FIG. 25, the brightness values of the four pixels 10 included in the spatially rendered region 100 respectively correspond to display grayscales Gc of 0, 0, 40 and 60, that is, the brightness of each of the four pixels 10 is smaller than the brightness corresponding to 64 grayscale.

In this embodiment, the brightness of each of the pixels 10 in the spatially rendered region 100 is relatively small, so as to avoid the occurrence of pixels 10 with too high brightness in the spatially rendered region 100, thereby affecting the visual effect of the conventional display region.

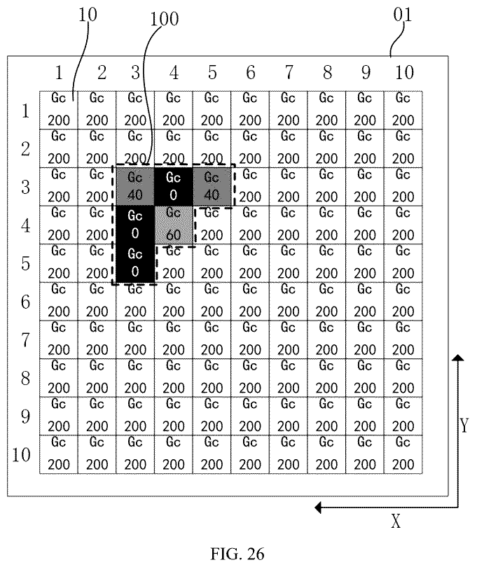

FIG. 26 is a schematic diagram of a display panel according to an embodiment of the present disclosure.

In an embodiment of the present disclosure, as shown in FIG. 24 to FIG. 26, the pixels 10 included in the display panel 01 are arranged in an array along a first direction X and a second direction Y, and the first direction X intersects with the second direction Y. In addition, among a plurality of pixels 10 included in a same spatially rendered region 100, pixels 10 arranged along the first direction X are arranged adjacently in sequence, and/or pixels 10 arranged along the second direction Y are arranged adjacently in sequence.

For example, as shown in FIG. 24 to FIG. 26, regardless of the shape of the spatially rendered region 100 being a rectangle or other shape different from the rectangle, when the display panel 01 displays the to-be-displayed image, the pixels 10 arranged along the first direction X in the spatially rendered region 100 are sequentially adjacently arranged and the pixels 10 arranged along the second direction Y are sequentially adjacently arranged. In this embodiment of the present disclosure, the pixels 10 in the spatially rendered region 100 are more concentrated, thereby making it easier to achieve brightness rendering. Furthermore, it avoids pixels 10 that is not in the spatially rendered region 100 from being surrounded or partially surrounded by pixels 10 in the spatially rendered region 100, thus also avoiding pixels 10 that is not in the spatially rendered region 100 from affecting the brightness rendering effect of the spatially rendered region 100.

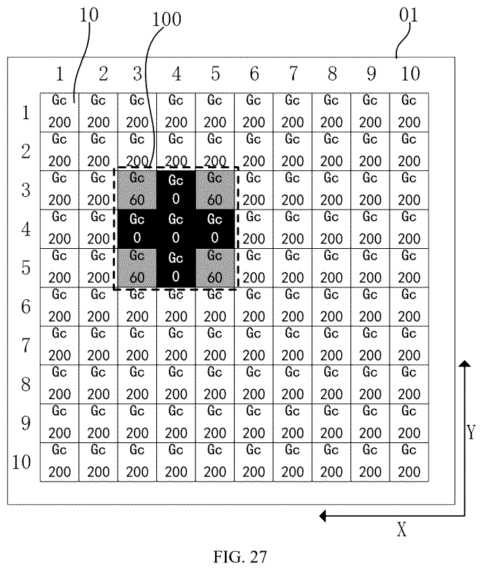

FIG. 27 is a schematic diagram of a display panel according to an embodiment of the present disclosure.

In an embodiment of the present disclosure, as shown in FIG. 27, pixels 10 with a same brightness included in a same spatially rendered region 100 are evenly arranged. For example, as shown in FIG. 27, pixels 10 with a display grayscale Gc of 60 in the spatially rendered region 100 are evenly arranged in the spatially rendered region 100, and pixels 10 with a display grayscale Gc of 0 in the spatially rendered region 100 are also evenly arranged in the spatially rendered region 100.

In an embodiment of the present disclosure, because pixels 10 with a same brightness in a same spatially rendered region 100 are evenly arranged in the region, displaying brightness of the spatially rendered region 100 may be relatively even.

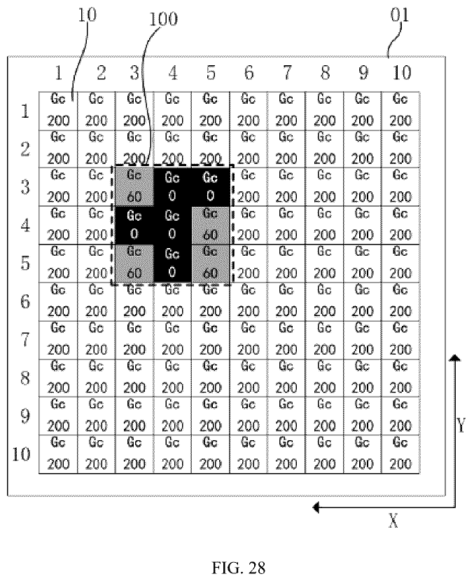

FIG. 28 is a schematic diagram of a display panel according to an embodiment of the present disclosure.

In an embodiment of the present disclosure, as shown in FIG. 28, pixels 100 with a same brightness included in the same spatially rendered region 100 are randomly arranged. For example, as shown in FIG. 28, pixels 10 with a display grayscale Gc of 60 in the spatially rendered region 100 are randomly arranged in the spatially rendered region 100, and pixels 10 with a display grayscale Gc of 0 are also randomly arranged in the spatially rendered region 100.

In an embodiment of the present disclosure, the pixels 10 with a same brightness in a same spatially rendered region 100 are randomly arranged, then the occurrence of obvious bright stripes, dark stripes, etc. on the display panel 01 at a specific viewing angle can be avoided, thereby improving the display effect of the display panel 01.

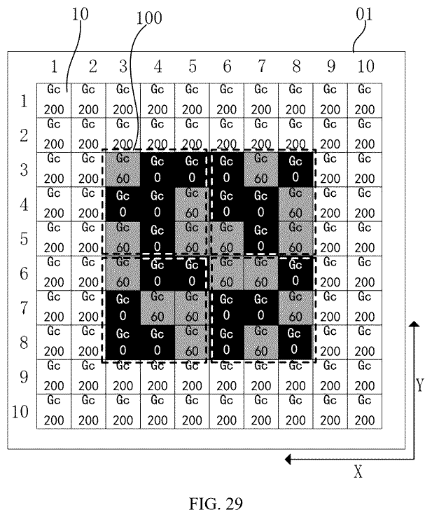

FIG. 29 is a schematic diagram of a display panel according to an embodiment of the present disclosure.

In an embodiment of the present disclosure, pixels 10 with a brightness greater than 0 included in adjacent spatially rendered regions 100 are randomly arranged. For example, as shown in FIG. 29, each of the 4 spatially rendered regions 100 includes a pixel 10 with a display grayscale Gc greater than 0, the 4 spatially rendered regions 100 are regarded as a whole, and pixels 10 with brightness values greater than 0 in the whole are randomly arranged.

In an embodiment of the present disclosure, the pixels 10 with a same brightness in a plurality of spatially rendered regions 100 are randomly arranged, then the occurrence of obvious bright stripes, dark stripes, etc. on the display panel 01 at a specific viewing angle can be avoided, thereby improving the display effect of the display panel 01.

In an embodiment of the present disclosure, as shown in FIG. 24 and FIG. 25, at least one spatially rendered region 100 includes more than 3 pixels 10 with different brightness values. For example, as shown in FIG. 24 and FIG. 25, the spatially rendered region 100 includes pixels 10 with display brightness values corresponding to display grayscales of 0, 40, and 60, respectively.

In an embodiment of the present disclosure, as shown in FIG. 24 to FIG. 29, a number of different brightness values of the plurality of pixels 10 in the spatially rendered region 100 is smaller than a number of pixels 10 included in the spatially rendered region 100. For example, as shown in FIG. 24, each spatially rendered region 100 includes 4 pixels 10, and the pixels 10 include 2 brightness values. For example, as shown in FIG. 25, each spatially rendered region 100 includes 4 pixels 10, and the pixels 10 include 3 brightness values. For example, as shown in FIG. 26, each spatially rendered region 100 includes 6 pixels 10, and the pixels 10 include 3 brightness values. For example, as shown in FIG. 27 to FIG. 29, each spatially rendered region 100 includes 9 pixels 10, and the pixels 10 include 2 brightness values.

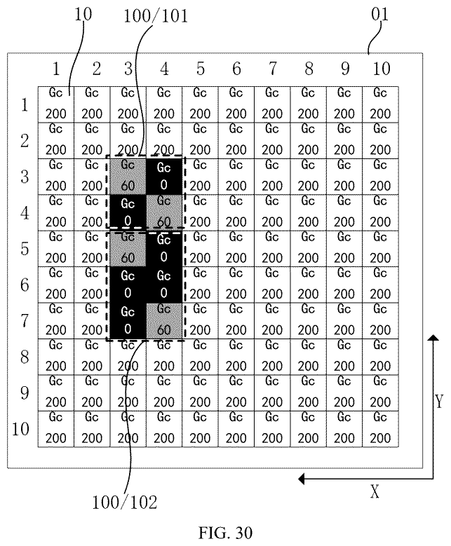

FIG. 30 is a schematic diagram of a display panel according to an embodiment of the present disclosure.

In an embodiment of the present disclosure, the spatially rendered regions 100 include a first spatially rendered region 101 and a second spatially rendered region 102. An average brightness of the first spatially rendered region 101 is within a third range, and a number of pixels 10 included in the first spatially rendered region 101 is n1. An average brightness of the second spatially rendered region 102 is within a fourth range, and a number of pixels 10 included in the second spatially rendered region 102 is m1. A maximum value of the third range is smaller than or equal to a minimum value of the fourth range, and n1 is greater than m1.

For example, as shown in FIG. 30, the average brightness of the first spatially rendered region 101 is smaller than the average brightness of the second spatially rendered region 102. Assuming that the pixels 10 with the brightness greater than 0 in the first spatially rendered region 101 and the second spatially rendered region 102 have a same brightness, then in order to render the pixels 10 included in the first spatially rendered region 101 to obtain relatively a low brightness, more pixels 10 with a brightness of 0 are required in the first spatially rendered region 101. Therefore, there may be more pixels 10 in the first spatially rendered region 101 than in the second spatially rendered region 102.

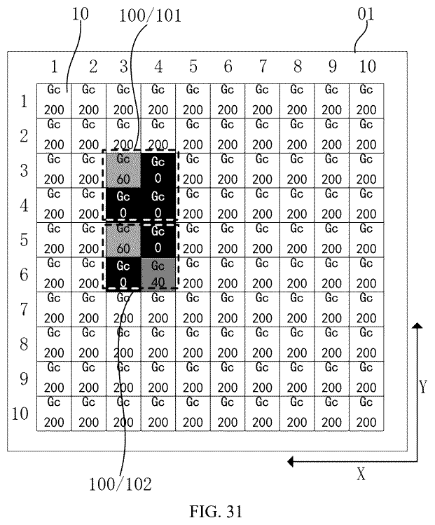

FIG. 31 is a schematic diagram of a display panel according to an embodiment of the present disclosure.

In an embodiment of the present disclosure, the spatially rendered regions 100 include a first spatially rendered region 101 and a second spatially rendered region 102. An average brightness of the first spatially rendered region 101 is within a third range, and the first spatially rendered region 101 includes pixels 10 with n2 different brightness values; an average brightness of the second spatially rendered region 102 is within a fourth range, and the second spatially rendered region 102 includes pixels 10 with m2 different brightness values. A maximum value of the third range is smaller than or equal to a minimum value of the fourth range, and n2 is greater than m2.

For example, as shown in FIG. 31, the average brightness of the first spatially rendered region 101 is smaller than the average brightness of the second spatially rendered region 102. In order to enable the second spatially rendered region 102 to have a possibility of obtaining richer rendering brightness after rendering, the second spatially rendered region 102 may have more pixels 10 with different brightness values than the first spatially rendered region 101. In FIG. 31, a number of pixels 10 with different brightness values in the first spatially rendered region 101 is 2, and a number of pixels 10 with different brightness values in the second spatially rendered region 102 is 3.

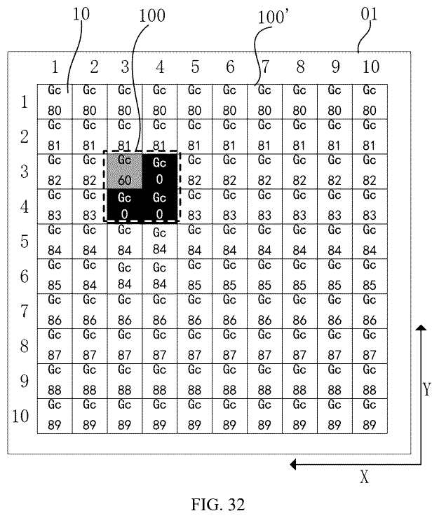

FIG. 32 is a schematic diagram of a display panel according to an embodiment of the present disclosure.

In an embodiment of the present disclosure, as shown in FIG. 32, when displaying at least one frame of an image, the display panel 01 further includes a conventional display region 100′. The conventional display region 100′ is a region excluding the spatially rendered region 100. The conventional display region 100′ includes pixels 10 with k1 different brightness values. The spatially rendered region 100 includes pixels 10 with k2 different brightness, where k1>k2. For example, K1 is 223 and K2 is 2 or 3 or 4.

Taking FIG. 32 as an example for illustration, when the display panel 01 displays one frame of an image, the display grayscales Gc of a plurality of pixels 10 in the conventional display region 100′ respectively correspond to 80-89. The display grayscales Gc of a plurality of pixels 10 in the spatially rendered region 100 are 0 and 60, respectively. When different display grayscales Gc of the pixels 10 in the spatially rendered region 100 are less, the corresponding rendering algorithm is relatively simple.

In a technical solution corresponding to this embodiment, the conventional display region 100′ includes pixels 10 with k1 different light-emitting durations, and the spatially rendered region 100 includes pixels with k2 different light-emitting durations. That is, the light-emitting durations of the pixels 10 respectively corresponding to k1 display grayscales Gc in the conventional display region 100′ are different, and the light-emitting durations of the pixels 10 respectively corresponding to k2 display grayscales Gc in the spatially rendered region 100 are different.

In an embodiment of the present disclosure, the pixel 19 in the display panel 01 includes a light-emitting diode (LED) chip, that is, the light-emitting structure in the pixel 19 is the light-emitting diode chip. The LED chip may be one of a micro-LED, a mini-LED, or the like. Since the light-emitting efficiency and optical characteristics of the LED chip are greatly affected by the current density, a driving method of PWM or a combination of PWM and PAM may be often adopted. When the pixels 10 in the display panel 01 are driven by PWM or the combination of PWM and PAM to perform light-emitting display, the technical solutions of the embodiments of the present disclosure can ensure flexible controllability of the brightness and smaller serious distortion during low-grayscale displaying.

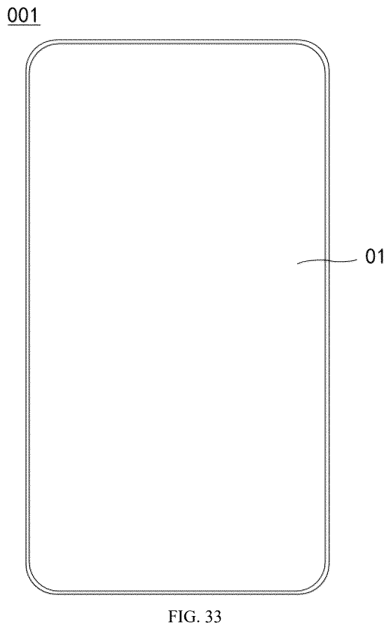

FIG. 33 is a schematic diagram of a display device according to an embodiment of the present disclosure.

As shown in FIG. 33, an embodiment of the present disclosure further provides a display device 001, including the display panel 01 according to any of the above embodiments. It should be understood that the display device 001 shown in FIG. 33 is merely illustrative, and the display device 001 may be any electronic device having a display function, such as a mobile phone, a tablet computer, a notebook computer, an e-book, a television, and a splicing display device.

According to the embodiments of the present disclosure, the brightness representation distortion problem of the display device 001 is relatively small, and the brightness of the region with low brightness is flexible and controllable.

The above descriptions are merely preferred embodiments of the present disclosure and are not intended to limit the present disclosure. It should be noted that any modifications, equivalent substitutions, improvements, and the like made within the spirit and principle of the present disclosure shall fall within the scope of the present disclosure.

What is claimed is:

1. A rendering method for a display panel comprising pixels, the rendering method comprising:
determining a to-be-rendered pixel data group according to image data of a to-be-displayed image, wherein the to-be-rendered pixel data group comprises a plurality of initial grayscales respectively corresponding to a plurality of pixels, and a reference grayscale of the to-be-rendered pixel data group is smaller than or equal to a first preset value, and the reference grayscale is one of the plurality of initial grayscales other than 0 grayscale in the to-be-rendered pixel data group; and
obtaining a corresponding spatially rendered pixel data group based on the plurality of initial grayscales in the to-be-rendered pixel data group, wherein the spatially rendered pixel data group comprises a plurality of rendered grayscales respectively corresponding to the plurality of pixels, a number of 0 grayscale in the spatially rendered pixel data group is greater than a number of 0 grayscale in the corresponding to-be-rendered pixel data group, and each of the plurality of rendered grayscales other than 0 grayscale in the spatially rendered pixel data group is greater than the first preset value.

2. The rendering method according to claim 1, wherein the first preset value is smaller than or equal to 64 grayscale.

3. The rendering method according to claim 2, wherein the first preset value is 32 grayscale.

4. The rendering method according to claim 1, wherein a difference between any two of the plurality of initial grayscales in the to-be-rendered pixel data group is smaller than or equal to a first threshold, and the first threshold is smaller than or equal to the first preset value.

5. The rendering method according to claim 1, wherein each of the plurality of initial grayscales in the to-be-rendered pixel data group is smaller than or equal to a second threshold, and the second threshold is smaller than or equal to the first preset value.

6. The rendering method according to claim 1, wherein the pixels comprised in the display panel are arranged in an array along a first direction and a second direction, and the first direction intersects with the second direction; and
among the plurality of pixels respectively corresponding to the plurality of initial grayscales in a same to-be-rendered pixel data group, the pixels arranged along the first direction are arranged adjacently in sequence, and/or the pixels arranged along the second direction are arranged adjacently in sequence.

7. The rendering method according to claim 1, wherein the reference grayscale is an initial grayscale with a maximum value among the plurality of initial grayscales in the to-be-rendered pixel data group.

8. The rendering method according to claim 1, wherein a grayscale value of the reference grayscale is a median of grayscale values of the plurality of initial grayscales in the to-be-rendered pixel data group.

9. The rendering method according to claim 1, wherein pixels respectively corresponding to the plurality of rendered grayscales in a same spatially rendered pixel data group are evenly arranged.

10. The rendering method according to claim 1, wherein pixels respectively corresponding to a same rendered grayscale in a same spatially rendered pixel data group are randomly arranged.

11. The rendering method according to claim 1, wherein pixels respectively corresponding to the rendered grayscales greater than 0 grayscale in a plurality of the spatially rendered pixel data groups are randomly arranged.

12. The rendering method according to claim 1, wherein in the spatially rendered pixel data group and the corresponding to-be-rendered pixel data group, a maximum initial grayscale corresponds to a maximum rendered grayscale, and a minimum initial grayscale corresponds to a minimum rendered grayscale.

13. The rendering method according to claim 1, wherein at least one spatially rendered pixel data group comprises 3 or more different rendered grayscales.

14. The rendering method according to claim 1, wherein a number of different grayscale values in the spatially rendered pixel data group is smaller than a number of rendered grayscales in the spatially rendered pixel data group.

15. The rendering method according to claim 1, wherein
when the reference grayscale of the to-be-rendered pixel data group is within a first range, a number of pixels respectively corresponding to the plurality of rendered grayscales in the corresponding spatially rendered pixel data group is n1;
when the reference grayscale of the to-be-rendered pixel data group is within a second range, a number of pixels respectively corresponding to the plurality of rendered grayscales in the corresponding spatially rendered pixel data group is m1; and
wherein a maximum value of the first range is smaller than or equal to a minimum value of the second range, and n1 is greater than m1.

16. The rendering method according to claim 1, wherein
when the reference grayscale of the to-be-rendered pixel data group is within a first range, the corresponding spatially rendered pixel data group comprises n2 different grayscale values;
when the reference grayscale of the to-be-rendered pixel data group is within a second range, the corresponding spatially rendered pixel data group comprises m2 different grayscale values; and
wherein a maximum value of the first range is smaller than or equal to a minimum value of the second range, and n2 is smaller than m2.

17. The rendering method according to claim 1, further comprising:
determining, for the plurality of rendered grayscales in the spatially rendered pixel data group, a driving duration of the pixel respectively corresponding to each of the plurality of rendered grayscales.

18. The rendering method according to claim 17, further comprising:
determining, for initial grayscales in a conventional pixel data group, a driving duration of the pixel respectively corresponding to each of the initial grayscales, wherein each of the initial grayscales in the conventional pixel data group is greater than the first preset value.

19. A display panel, comprising pixels, wherein the pixels are configured to display Q1 brightness values; the display panel comprises at least one spatially rendered region when displaying at least one frame of an image; and
one of the at least one spatially rendered region comprises a plurality of pixels; in each of the at least one spatially rendered region, a brightness of each pixel other than a pixel with a brightness of 0 is greater than a second preset value; and when the pixel is within the spatially rendered region, the pixel is configured to display part of the Q1 brightness values.

20. The display panel according to claim 19, wherein the second preset value is smaller than or equal to a brightness value corresponding to 64 grayscale.

21. The display panel according to claim 19, wherein the second preset value is a brightness value corresponding to 32 grayscale.

22. The display panel according to claim 19, wherein a difference between brightness values of any two of the pixels with a brightness greater than 0 in the spatially rendered region is smaller than or equal to a third threshold, and the third threshold is smaller than or equal to the second preset value.

23. The display panel according to claim 19, wherein a brightness of each pixel in the spatially rendered region is smaller than or equal to a fourth threshold, and the fourth threshold is smaller than or equal to the second preset value.

24. The display panel according to claim 19, wherein the pixels in the display panel are arranged in an array along a first direction and a second direction, and the first direction intersects with the second direction; and
among the plurality of pixels in a same spatially rendered region, the pixels arranged along the first direction are arranged adjacently in sequence, and/or the pixels arranged along the second direction are arranged adjacently in sequence.

25. The display panel according to claim 19, wherein the pixels with a same brightness in a same spatially rendered region are evenly arranged.

26. The display panel according to claim 19, wherein the pixels with a same brightness in a same spatially rendered region are randomly arranged.

27. The display panel according to claim 19, wherein the pixels with a brightness greater than 0 in a plurality of adjacent spatially rendered regions are randomly arranged.

28. The display panel according to claim 19, wherein one of the at least one spatially rendered region comprises pixels with three or more different brightness values.

29. The display panel according to claim 19, wherein a number of different brightness values of the plurality of pixels in the spatially rendered region is smaller than a number of the pixels in the spatially rendered region.

30. The display panel according to claim 19, wherein the at least one spatially rendered region comprises a first spatially rendered region and a second spatially rendered region;
an average brightness of the first spatially rendered region is within a third range, and a number of pixels in the first spatially rendered region is n1;
an average brightness of the second spatially rendered region is within a fourth range, and a number of pixels in the second spatially rendered region is m1; and
a maximum value of the third range is smaller than or equal to a minimum value of the fourth range, and n1 is greater than m1.

31. The display panel according to claim 19, wherein the at least one spatially rendered region comprises a first spatially rendered region and a second spatially rendered region;
an average brightness of the first spatially rendered region is within a third range, and the first spatially rendered region comprises pixels with n2 different brightness values;
an average brightness of the second spatially rendered region is within a fourth range, and the second spatially rendered region comprises pixels with m2 different brightness values; and
a maximum value of the third range is smaller than or equal to a minimum value of the fourth range, and n2 is greater than m2.

32. The display panel according to claim 19, wherein when displaying at least one frame of an image, the display panel further comprises a conventional display region, and the conventional display region is a region excluding the spatially rendered region; and
the conventional display region comprises pixels with k1 different brightness values, and the spatially rendered region comprises pixels with k2 different brightness values, and k1>k2.

33. The display panel according to claim 32, wherein the conventional display region comprises pixels with k1 different light-emitting durations, and the spatially rendered region comprises pixels with k2 different light-emitting durations.

34. The display panel according to claim 19, wherein each of the pixels comprises a light-emitting diode chip.

35. A display device, comprising a display panel comprising pixels, wherein the pixels are configured to display Q1 brightness values; the display panel comprises at least one spatially rendered region when displaying at least one frame of an image; and
one of the at least one spatially rendered region comprises a plurality of pixels; in each of the at least one spatially rendered region, a brightness of each pixel other than a pixel with a brightness of 0 is greater than a second preset value; and when the pixel is within the spatially rendered region, the pixel is configured to display part of the Q1 brightness values.
